(19) United States
(12) Patent Application Publication
(10) Pub. No.: US 2024/0145181 A1
(43) Pub. Date: May 2, 2024

(54) METHOD FOR MANUFACTURING MULTILAYER CERAMIC ELECTRONIC COMPONENT

(71) Applicant: KYOCERA Corporation, Kyoto-shi, Kyoto (JP)

(72) Inventor: Hisashi SATO, Kirishima-shi, Kagoshima (JP)

(73) Assignee: KYOCERA Corporation, Kyoto-shi, Kyoto (JP)

(21) Appl. No.: 18/278,278

(22) PCT Filed: Feb. 1, 2022
(86) PCT No.: PCT/JP2022/003843

§ 371 Date: Aug. 22, 2023

(30) Foreign Application Priority Data
Feb. 24, 2021 (JP) 2021-027848

(51) Int. Cl. H01G 13/00; H01G 4/30

(52) U.S. Cl. CPC H01G 13/00; H01G 4/30

(57) ABSTRACT

A method for manufacturing a multilayer ceramic electronic component includes cutting, at predetermined intervals, a multilayer base to form a plurality of first rods extending in a first direction, placing a resin on at least one surface of each of the plurality of first rods and between adjacent first rods of the plurality of first rods to form a flat block including the plurality of first rods fixed to one another, cutting the flat block at predetermined intervals in a second direction orthogonal to the first direction to form a plurality of second rods including a plurality of base precursors aligned, machining a cut surface of each of the plurality of second rods including the plurality of base precursors to form a plurality of base components, firing the plurality of base components to sinter the plurality of base components, and removing the resin.

### TECHNICAL FIELD

The present disclosure relates to a method for manufacturing a multilayer ceramic electronic component. The present disclosure particularly relates to a method for manufacturing a multilayer ceramic electronic component by cutting a multilayer base including ceramic green sheets and electrode layers that are stacked on one another to obtain base components and firing the base components.

### BACKGROUND OF INVENTION

Patent Literature 1 describes an example known method for manufacturing a multilayer ceramic electronic component.

### CITATION LIST

### Patent Literature

Patent Literature 1: Japanese Unexamined Patent Application Publication No. 2006-128285

### SUMMARY

In an aspect of the present disclosure, a method for manufacturing a multilayer ceramic electronic component includes cutting, at predetermined intervals, a multilayer base including ceramic green sheets and electrode layers stacked alternately to form a plurality of first rods extending in a first direction, placing a resin on at least one surface of each of the plurality of first rods and between adjacent first rods of the plurality of first rods to form a flat block including the plurality of first rods fixed to one another, cutting the flat block at predetermined intervals in a second direction orthogonal to the first direction to form a plurality of second rods including a plurality of base precursors aligned in a row, machining a cut surface of each of the plurality of second rods including the plurality of base precursors to form a plurality of base components, firing the plurality of base components to sinter the plurality of base components, and removing the resin.

In another aspect of the present disclosure, a method for manufacturing a multilayer ceramic electronic component includes cutting, at predetermined intervals, a multilayer base including ceramic green sheets and electrode layers stacked alternately to form a plurality of first rods. Each of the plurality of first rods extends in a first direction and includes a first main surface, a second main surface opposite to the first main surface, a first cut surface, and a second cut surface opposite to the first cut surface. The method further includes aligning the plurality of first rods at a constant gap from one another to place a resin in the constant gap to form a flat block including the plurality of first rods fixed to one another, cutting the flat block at predetermined intervals in a second direction orthogonal to the first direction to form a plurality of second rods including a plurality of base precursors aligned in a row, machining a cut surface of each of the plurality of second rods including the plurality of base precursors to form a plurality of base components, firing the plurality of base components to sinter the plurality of base components, and removing the resin.

### BRIEF DESCRIPTION OF THE DRAWINGS

The objects, features, and advantages of the present disclosure will become more apparent from the following detailed description and the drawings.

FIG. 1 is a schematic perspective view of an example multilayer ceramic capacitor.

FIG. 2 is a schematic perspective view of a base component of the multilayer ceramic capacitor in FIG. 1.

FIG. 3 is a schematic perspective view of a precursor of the base component in FIG. 2.

FIG. 4 is a schematic perspective view of a green sheet on which electrodes are printed.

FIG. 5 is a schematic perspective view of a stack of green sheets on each of which electrodes are printed.

FIG. 6 is a schematic perspective view of a multilayer base for manufacturing the multilayer ceramic capacitor in FIG. 1.

FIG. 7 is a schematic perspective view of first rods obtained by cutting the multilayer base in FIG. 6.

FIG. 8 is a schematic perspective view of the first rods placed on an adhesive stretchable sheet.

FIG. 9 is a schematic cross-sectional view of the first rods that are covered with resin powder and heated.

FIG. 10 is a schematic cross-sectional view of a flat plate placed on the resin and pressed.

FIG. 11 is a schematic perspective view of a flat block.

FIG. 12 is a schematic perspective view of second rods obtained by cutting the flat block in FIG. 11.

FIG. 13 is a schematic perspective view of the second rods in FIG. 12 that are turned about their axes.

FIG. 14 is a schematic perspective view of a flat bar assembly obtained by assembling the second rods in FIG. 13.

FIG. 15 is a schematic side view of a surface of the flat bar assembly with the surface being polished.

FIG. 16 is a schematic cross-sectional view of first rods formed integrally by melt bonding of resin powder.

FIG. 17 is a schematic perspective view of a flat block.

FIG. 18 is a schematic perspective view of second rods obtained by cutting the flat block in FIG. 17.

FIG. 19 is a schematic perspective view of the second rods in FIG. 18 that are turned about their axes.

FIG. 20 is a schematic perspective view of a flat bar assembly obtained by assembling the second rods in FIG. 19.

FIG. 21 is a schematic perspective view of the flat bar assembly having ceramic green sheets bonded to the two surfaces.

FIG. 22 is a schematic perspective view of the flat bar assembly having the ceramic green sheets bonded to two surfaces.

FIG. 23 is a schematic perspective view of the flat bar assembly after firing.

FIG. 24 is a schematic perspective view of a fired base component after barrel polishing.

FIG. 25A is a schematic cross-sectional view of first rods sandwiched between a support sheet and a resin sheet and heated.

FIG. 25B is a schematic cross-sectional view of first rods sandwiched between two resin sheets and heated.

FIG. 26 is a schematic cross-sectional view of the first rods fixed to one another by a resin.

FIG. 27 is a schematic cross-sectional view of first rods covered with resin powder and heated.

FIG. 28 is a schematic cross-sectional view of a flat plate placed on the resin and pressed.

FIG. 29 is a schematic perspective view of a flat block.

FIG. 30 is a schematic perspective view of second rods obtained by cutting the flat block in FIG. 29.

FIG. 31 is a schematic perspective view of the second rods in FIG. 30 that are turned about their axes.

FIG. 32A is a schematic cross-sectional view of the second rods in FIG. 31 each having a cut surface immersed in and coated with slurry.

FIG. 32B is a schematic cross-sectional view of the second rods in FIG. 31 each having the cut surface immersed in and coated with the slurry.

FIG. 33 is a schematic perspective view of the second rods each having the slurry applied to side surfaces.

FIG. 34 is a schematic perspective view of the second rods after firing.

FIG. 35 is a schematic perspective view of a flat bar assembly obtained by assembling the second rods in FIG. 31.

FIG. 36 is a schematic perspective view of the flat bar assembly in FIG. 35 having a ceramic green sheet being transferred to its surface.

FIG. 37 is a schematic perspective view of the flat bar assembly in FIG. 35 having a ceramic green sheet transferred to its surface and then having a substrate released off.

FIG. 38 is a schematic perspective view of the flat bar assembly with ceramic green sheets as protective layers bonded to its surfaces.

FIG. 39 is a schematic perspective view of the flat bar assembly after firing.

FIG. 40 is a schematic perspective view of a flat bar assembly having ceramic slurry transferred to its surface.

FIG. 41 is a schematic cross-sectional view of a flat bar assembly immersed in ceramic slurry.

FIG. 42 is a schematic perspective view of the flat bar assembly being dried.

FIG. 43 is a schematic perspective view of first rods placed collectively and each having a cut surface facing upward.

FIG. 44 is a schematic perspective view of first rods separated from one another on an adhesive stretchable sheet.

FIG. 45 is a schematic cross-sectional view of the first rods with resin powder filling gaps between the first rods.

FIG. 46 is a schematic cross-sectional view of a flat plate placed on a resin and pressed.

FIG. 47 is a schematic perspective view of a flat block.

FIG. 48 is a schematic perspective view of second rods obtained by cutting the flat block.

FIG. 49 is a perspective view of the assembled second rods after cutting.

### DESCRIPTION OF EMBODIMENTS

The structure that forms the basis of a method for manufacturing a multilayer ceramic electronic component according to one or more embodiments of the present disclosure will be described. Recent small and highly functional electronic devices incorporate smaller electronic components. Examples of such electronic components include multilayer ceramic capacitors that typically have a size of 1 mm or less on each side.

As described in, for example, Patent Literature 1, the multilayer ceramic electronic component is manufactured by cutting a multilayer base including ceramic green sheets and electrode layers that are stacked to obtain base components, firing the base components, and processing the fired base components with predetermined processing.

For recent smaller multilayer ceramic electronic components, handling of the base components is increasingly difficult with known methods for manufacturing multilayer ceramic electronic components. This may lower the product quality or increase the manufacturing cost.

The method for manufacturing the multilayer ceramic electronic components according to one or more embodiments of the present disclosure will be described below with reference to the drawings. A method for manufacturing a multilayer ceramic capacitor as an example multilayer ceramic electronic component will be described below. However, the method for manufacturing the multilayer ceramic electronic components according to one or more embodiments of the present disclosure is usable to manufacture, in addition to a multilayer ceramic capacitor, various multilayer ceramic electronic components, such as stacked piezoelectric elements, stacked thermistor elements, stacked chip coils, and multilayer ceramic substrates.

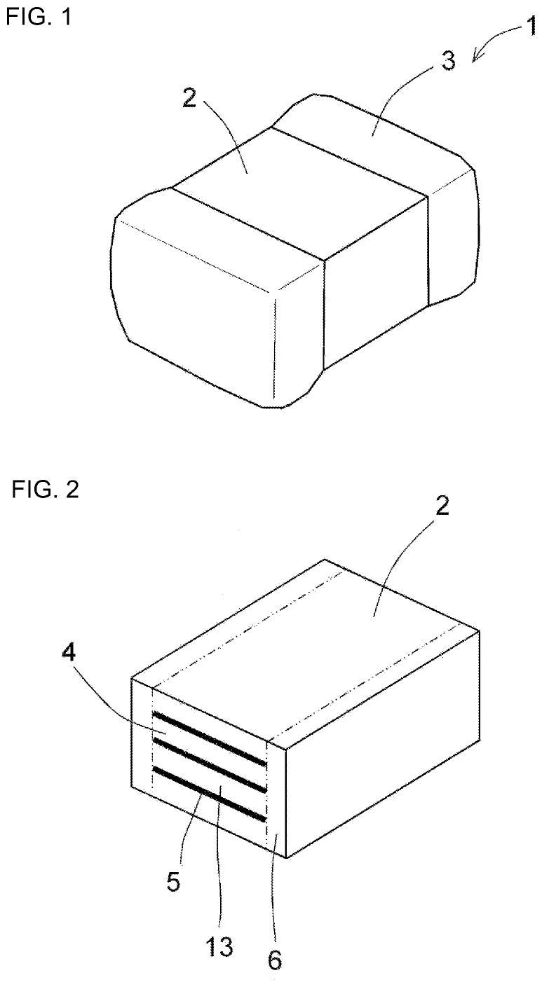

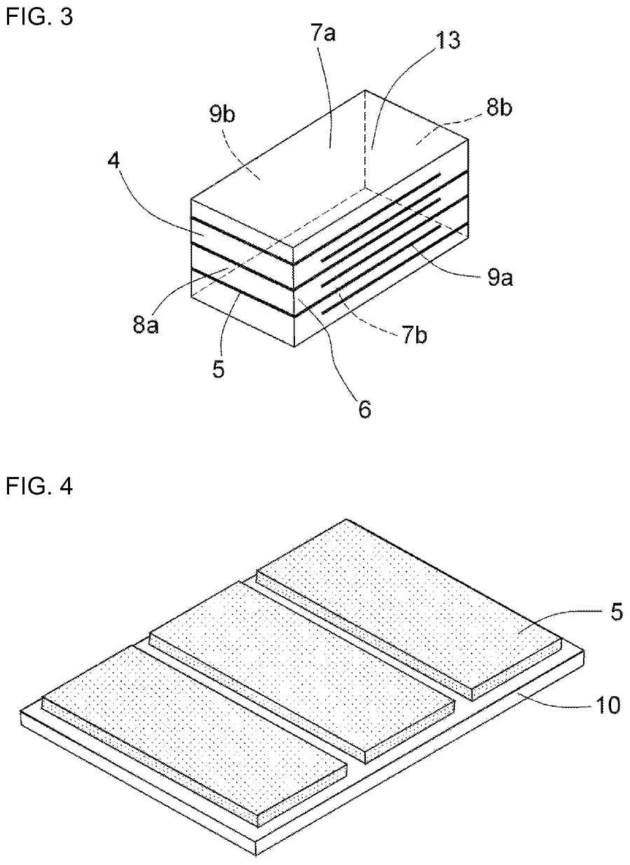

The multilayer ceramic capacitor as an example multilayer ceramic electronic component will first be described. FIG. 1 is a perspective view of an example multilayer ceramic capacitor. FIG. 2 is a schematic perspective view of a base component of the multilayer ceramic capacitor in FIG. 1. FIG. 2 is a diagram of the base component before firing. The base component shrinking after firing has the same structure as before firing. FIG. 2 is thus also a diagram of the base component after firing. FIG. 3 is a perspective view of a precursor of the base component in FIG. 2. The precursor of the base component may be hereafter referred to as a base precursor.

A multilayer ceramic capacitor 1 includes a base component 2 and external electrodes 3. As illustrated in FIG. 2, the base component 2 is substantially a rectangular prism. The base component 2 includes dielectric ceramic and multiple internal electrodes 5 connected to the external electrodes 3. The external electrodes 3 are located on a pair of end faces of the base component 2 and extend to other adjacent faces. The internal electrodes 5 extend inward from the pair of end faces of the base component 2 and are alternately stacked without contact with each other.

Each external electrode 3 includes an under layer connecting to the base component 2 and a plated outer layer that facilitates mounting of an external wire to the external electrode 3 by soldering. The under layer may be applied to the base component 2 after firing by thermal treatment. The under layer may be placed on the base component 2 before firing and fired together with the base component 2. The external electrode 3 may include multiple under layers and multiple plated outer layers to have an intended function. The external electrode 3 may include no plated outer layer and may include the under layer and a conductive resin layer.

As illustrated in FIGS. 2 and 3, the base component 2 includes a base precursor 13 and protective layers 6. As illustrated in FIG. 3, the base precursor 13 is substantially a rectangular prism. The base precursor 13 includes a first main surface 7a and a second main surface 7b opposite to each other, a first end face 8a and a second end face 8b opposite to each other, and a first side surface 9a and a second side surface 9b opposite to each other. Hereafter, the first main surface 7a and the second main surface 7b may be simply referred to as the main surfaces 7 without distinguishing the individual main surfaces. Similarly, the first end face 8a and the second end face 8b may be simply referred to as the end faces 8 without distinguishing the individual end faces. The first side surface 9a and the second side surface 9b may be simply referred to as the side surfaces 9 without distinguishing the individual side surfaces.

The internal electrodes 5 are exposed on the end faces 8 and the side surfaces 9 of the base precursor 13. The protective layers 6 are located on the side surfaces 9 of the base precursor 13. The protective layers 6 reduce the likelihood of electrical short-circuiting between the internal electrodes 5 exposed on the first end face 8a and the internal electrodes 5 exposed on the second end face 8b. The protective layers 6 also physically protect exposed portions of the internal electrodes 5 on the side surfaces 9 of the base precursor 13. The protective layers 6 are attached in a final process in manufacturing the base component 2. The protective layers 6 protect the internal electrodes 5 exposed on the side surfaces 9 of the base precursor 13. The protective layers 6 may be made of a ceramic material. In this case, the protective layers 6 may be insulating and have high mechanical strength. The ceramic material to be the protective layers 6 is normally applied to the base precursor 13 before firing. The boundaries between the base precursor 13 and the protective layers 6 indicated by two-dot-dash lines in FIG. 2 actually appear unclear.

The method for manufacturing the base component 2 in FIG. 2 and the multilayer ceramic capacitor 1 in FIG. 1 will now be described.

A ceramic mixture powder containing a ceramic dielectric material of BaTiO₃ with an additive is first wet-milled and blended using a bead mill. A polyvinyl butyral binder, a plasticizer, and an organic solvent are added to this milled and blended slurry and mixed together to prepare ceramic slurry.

A die coater is then used to form a ceramic green sheet 10 on a carrier film. The ceramic green sheet 10 may have a thickness of, for example, about 1 to 10 μm. A thinner ceramic green sheet 10 can increase the capacitance of the multilayer ceramic capacitor. The ceramic green sheet 10 may be shaped with, for example, a doctor blade coater or a gravure coater, rather than with the die coater.

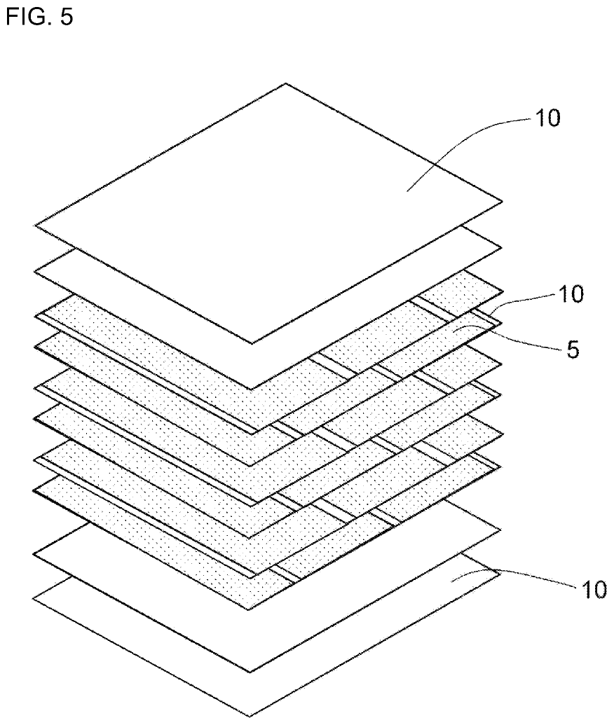

As illustrated in FIG. 4, a conductive paste including a metal material, which is to be the internal electrodes 5, is printed by screen printing on the prepared ceramic green sheet 10 in a predetermined pattern. The conductive paste may be printed by, for example, gravure printing, rather than by screen printing. The conductive paste may contain a metal such as Ni, Pd, Cu, or Ag, or an alloy of these metals. FIG. 3 illustrates example internal electrodes 5 in a strip pattern in multiple rows. In some embodiments, the internal electrodes 5 may be in, for example, an individual electrode pattern.

Thinner internal electrodes 5 that allow the capacitor to function can reduce internal defects resulting from internal stress. For a capacitor with a stack of many layers, the internal electrodes 5 may each have, for example, a thickness of 1.0 μm or less.

As illustrated in FIG. 5, a predetermined number of ceramic green sheets 10 with printed internal electrodes 5 are stacked on a stack of a predetermined number of ceramic green sheets 10, and a predetermined number of ceramic green sheets 10 are stacked on the stack of ceramic green sheets 10 with printed internal electrodes 5. The predetermined number of ceramic green sheets 10 with the printed internal electrodes 5 are stacked to have the patterns of the internal electrodes 5 deviating from each other. Although not illustrated in FIG. 5, the ceramic green sheets 10 are stacked on a support sheet. The support sheet may be an adhesive releasable sheet that is adhesive and releasable, such as a low-tack sheet or a foam releasable sheet.

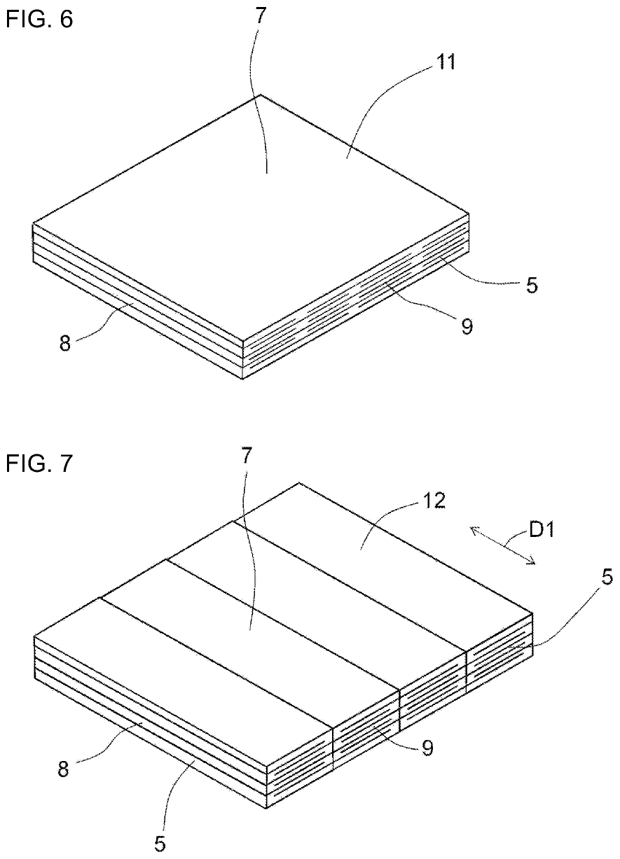

The stack of multiple layers of the ceramic green sheets 10 is then pressed in the stacking direction to obtain an integrated multilayer base 11 as illustrated in FIG. 6. The stack may be pressed using, for example, a hydrostatic press device. In the multilayer base 11, the internal electrodes 5 are buried in layers between the ceramic green sheets 10. The multilayer base 11 is cut vertically and horizontally to be the base precursors 13 illustrated in FIG. 3. The main surfaces, the end faces, and the side surfaces of the multilayer base 11, corresponding respectively to the main surfaces 7, the end faces 8, and the side surfaces 9 of the base precursor 13, are hereafter denoted with the same reference signs. Although not illustrated in FIG. 6, the support sheet, which is used in stacking the ceramic green sheets 10, is located under the multilayer base 11.

Subsequently, as illustrated in FIG. 7, the multilayer base 11 is cut into multiple first rods 12 extending in a first direction D1 with predetermined dimensions using a press-cutting device. Each first rod 12 includes the cutting surfaces corresponding to the end faces 8 of the base precursor 13. The internal electrodes 5 are exposed on the cutting surfaces of the first rod 12. The multilayer base 11 may be cut with any device other than a press-cutting device. For example, the multilayer base 11 may be cut with a dicing saw. The cutting of the multilayer base 11 into the multiple first rods 12 may be herein referred to as first cutting.

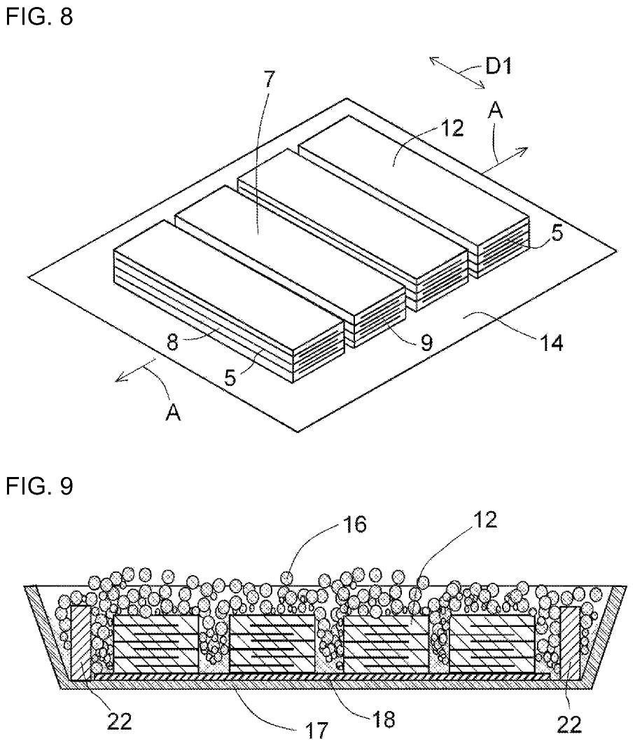

As illustrated in FIG. 8, the multiple first rods 12 illustrated in FIG. 7 are then placed on an adhesive stretchable sheet 14. Two ends of the adhesive stretchable sheet 14 are stretched in the directions indicated by arrows A to increase intervals between the multiple first rods 12 adjacent to one another. The gaps between the first rods 12 may be adjusted by adjusting the stretching length of the adhesive stretchable sheet 14. For the first rods 12 having excess gaps between them, the amount of resin powder used in subsequent processes is to be increased. The first rods 12 may be arranged at intervals to allow the resin powder to flow into the gaps between the first rods 12. More specifically, with resin powder having a fine particle size being used, the gap between the first rods 12 may be greater than or equal to twice the mean particle size of the resin powder.

In the present embodiment, as described above, the gaps between the first rods 12 can be controlled by adjusting the stretching length of the adhesive stretchable sheet 14. This minimizes the amount of resin powder used to fix the first rods 12 in the subsequent processes. This thus reduces the material cost for manufacturing the multilayer ceramic capacitor.

Through the cutting with a cut width, for example, the cutting with a dicing saw, the gaps between the first rods 12 may not be adjusted. Through the cutting with the press-cutting device, the cut groove width is almost zero, but a molten resin can flow partially into the slight gaps between the first rods 12 in the subsequent processes and can be integral with a resin located on the first rods 12, thus allowing the first rods 12 to be fixed to one another. For the machining performed in the subsequent processes, the cutting with a press-cutting blade may eliminate the processing for leaving distances between the first rods 12 adjacent to one another.

The processes illustrated in FIGS. 4 to 8 are common in each embodiment described below. A first embodiment will now be described.

### First Embodiment

In the present embodiment, as illustrated in FIG. 9, a flat bottom pan 17 with a flat bottom is first prepared, and the multiple first rods 12 are placed on the bottom of the flat bottom pan 17 together with a support sheet 18. The first rods 12 and the support sheet 18 are placed on the bottom of the flat bottom pan 17, with the support sheet 18 being in contact with the bottom. Resin powder 16 of a thermoplastic resin is then placed on at least one surface of each first rod 12. The resin powder 16 is then heated to melt.

After the resin powder 16 is placed, the multiple first rods 12 may receive vibration before the resin powder 16 is heated. This allows the resin powder 16 to fill the gaps between the first rods 12 adjacent to one another and also increases the degree of filling of the resin powder 16 in the gaps. The mean particle size of the resin powder 16 may be less than or equal to half the length of each gap to increase the degree of filling of the resin powder 16 in the gaps. The mean particle size of the resin powder 16 may be about 20 to 30 μm. The length of each gap between the first rods 12 may be, for example, about 100 μm.

In the present embodiment, the resin powder 16 is placed to fill the gaps under vibration, and then a parallel partition (not illustrated) is placed at a predetermined distance from the surfaces (upper surfaces) of the first rods 12 and slid along the surfaces of the first rods 12 to scrap off an excess portion of the resin powder 16. The resin powder 16 is heated to a predetermined temperature to at least partially melt. The predetermined temperature may be set based on, for example, the melting point of the material of the resin powder 16. The predetermined temperature may be, for example, about 180° C.

The resin powder 16 of a thermoplastic resin melts upon heating. The molten resin 15 then flows downward into the gaps between the first rods 12. In this state, air remaining in the gaps flows out through a space between particles of the resin powder 16. The air is forced out of the gaps, and the molten resin 15 fills the gaps from below. The air forced out onto the surfaces of the first rods 12 may form a large foamy dome of the resin 15, which is a surface film and thus does not affect the filling of the gaps between the first rod 12 with the resin 15.

The melting point of the thermoplastic resin 15 may be lower than or equal to the decomposition temperature of the binder contained in the ceramic green sheets 10 and the internal electrodes 5. This reduces deterioration of the first rods 12 during melting of the resin 15, thus improving the product quality. The resin 15 may not contain, for example, a metal, chlorine, or fluorine. This reduces the likelihood that a substance such as a metal, chlorine, or fluorine remains on the surface of the fired base component 2 and deteriorates the product properties.

For the wettability of the molten resin 15 with respect to the first rods 12, the contact angle of the molten resin 15 to the first rods 12 may be 30 degrees or less. With the contact angle being greater, the first rods 12 may repel the molten resin, leaving a void between the molten resin 15 and the first rods 12. In this state, the first rods 12 are less likely to be fixed to one another with the resin 15. With the contact angle being 30 degrees or less, the wettability of the molten resin 15 with respect to the first rods 12 increases, thus allowing the resin 15 to firmly fix the first rods 12 to one another.

The resin 15 may not contain any oil or fat material such as wax. The resin 15 is to be left in a temperature environment of, for example, 90 to 120° C. in the subsequent processes, or for example, in drying the ceramic green sheet placed on the second rods as the protective layer 6. The oil or fat material such as wax cannot retain shape at such temperatures. The molten wax may further dissolve the binder in the ceramic green sheet, possibly expanding or deforming the base component 2. This issue can be avoided by the resin 15 containing no oil or fat material such as wax.

The resin 15 may be any resin other than a curable reactive resin. The curable reactive resin shrinks greatly when cured, and may thus deform the base component 2. The curable reactive resin can typically decompose thermally at high temperatures, causing difficulty in firing to remove the resin without affecting the product quality.

As described above, the resin 15 as the resin powder 16, or in other words, the resin 15 for fixing the first rods 12 to one another, is a thermoplastic resin. Examples of the thermoplastic resin 15 include polyethylene, polypropylene, polystyrene, acrylonitrile styrene, a methacrylic resin, polyethylene terephthalate, polyvinyl alcohol, a polyurethane resin, a polyethylene oxide resin, and methacrylic acid ester polymers.

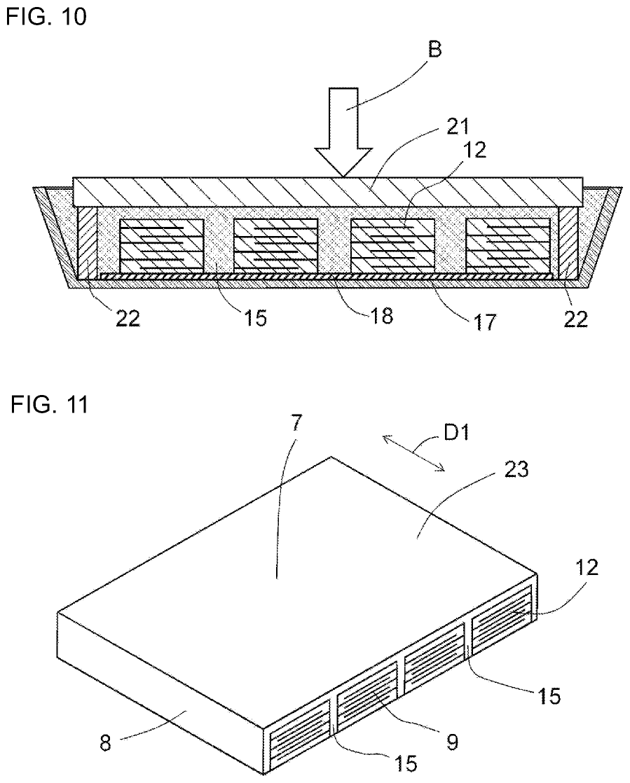

In the present embodiment, as illustrated in FIG. 10, with the gaps between the first rods 12 being filled with the molten resin 15, a flat plate 21 is placed on the molten resin 15 and pressed in the direction indicated by arrow B. The flat plate 21 sinks ink into the molten resin 15 under a pressing force, but is stopped by spacers 22 surrounding the first rods 12. With the resin 15 left to cool down, a layer of the resin 15 forms on the first rods 12. The flat plate 21 may be pressed with, for example, a press machine.

FIG. 11 illustrates a flat block 23 including multiple first rods 12 integrally fixed to one another with the resin. The first rods 12 extend in the first direction D1. With the resin filling the space between the first rods 12 adjacent to one another and extending to the resin layer on the first rods 12, the flat block 23 includes a flat resin surface.

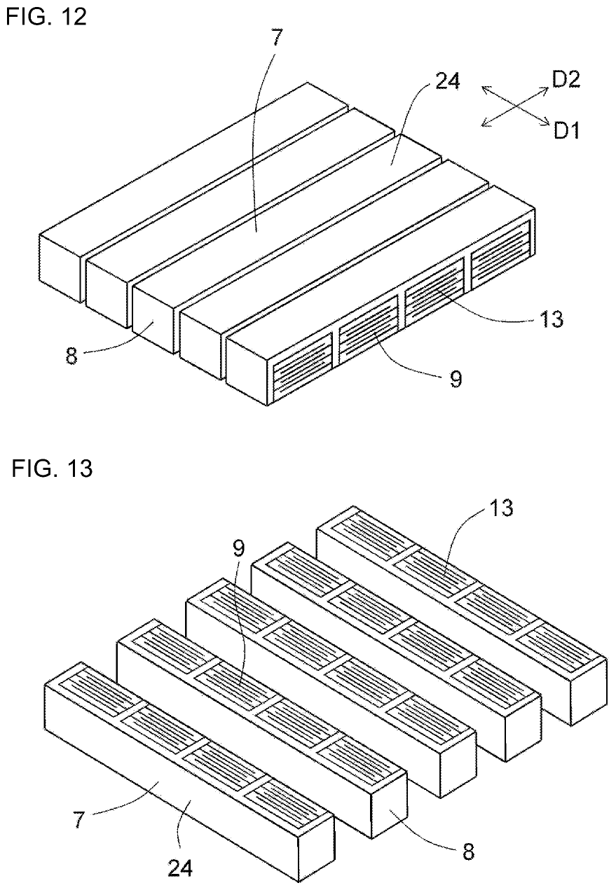

The flat block 23 illustrated in FIG. 11 is then cut at predetermined intervals in a second direction D2 orthogonal to the first direction D1. FIG. 12 illustrates multiple second rods 24 obtained by cutting the flat block 23. The cutting of the flat block 23 to obtain the multiple second rods 24 may be herein referred to as second cutting. The second cutting is performed in a direction orthogonal to the direction of the first cutting. Each second rod 24 includes cut surfaces corresponding to the side surfaces 9 of the base precursor 13. The internal electrode 5 is exposed on each cut surface. In this state, each individual multilayer ceramic electronic component corresponds to the base precursor 13 illustrated in FIG. 3.

For the flat block 23 including an uneven upper surface in FIG. 11, the second cutting may be less accurate. In the present embodiment, as illustrated in FIG. 10, the flat plate 21 pressed to apply a pressure to the resin 15 allows the flat block 23 to include a flat upper surface. This structure increases the accuracy of the second cutting and improves the product quality.

As illustrated in FIG. 13, each of the multiple second rods 24 is turned by 90 degrees about the corresponding axis to include one of the corresponding cut surfaces resulting from the second cutting (the surface on which each internal electrode 5 is exposed) facing upward. When each of the multiple second rods 24 is turned, an external force may be applied to the corresponding second rod 24. However, the base precursors 13 firmly fixed to one another with the resin are less likely to slip off, or the second rods 24 are less likely to deform.

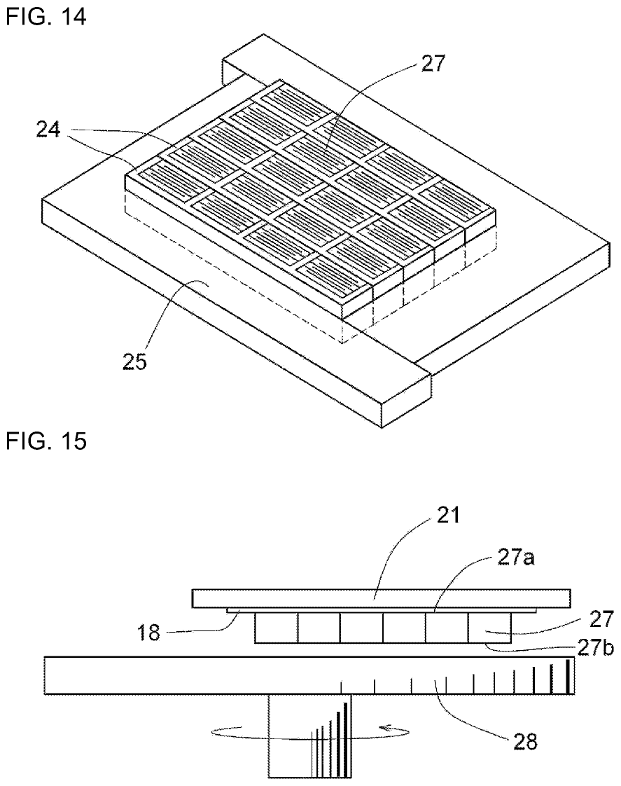

The multiple second rods 24 are assembled into a flat bar assembly 27. In forming the flat bar assembly 27 as illustrated in FIG. 14, two L-shaped frame plates 25 may be used to hold the second rods 24 laterally from outside. In the flat bar assembly 27, the cut surfaces of the second rods 24 may be located substantially in the same plane. The cut surfaces resulting from the second cutting (the surfaces on which the internal electrodes 5 are exposed) correspond to the upper and lower surfaces of the flat bar assembly 27, or in other words, the front and rear surfaces of the flat bar assembly. Each cut surface resulting from the second cutting may be referred to as an electrode exposed surface.

Although the electrode exposed surfaces may be machined in the state illustrated in FIG. 14, the flat bar assembly 27 is heated before the machining and stops being heated immediately after the resin starts melting in the present embodiment. This allows the second rods 24 adjacent to one another to be at least partially bonded with the resin, thus allowing the flat bar assembly 27 to retain shape although the frame plates 25 are removed. This structure facilitates handling of the flat bar assembly 27 in the subsequent processes. The flat bar assembly 27 includes the upper surface and the lower surface as the cut surfaces of the multiple second rods 24 resulting from the second cutting. The multiple second rods 24 can thus be handled as a single component. This structure facilitates the machining of the cut surfaces in the subsequent processes, and thus improves the productivity and the product quality of the multilayer ceramic electronic components.

The support sheet 18 as an adhesive releasable sheet is bonded and fixed to a first surface 27a (one main surface) of the flat bar assembly 27. As illustrated in FIG. 15, an abrasive disc 28 is used for polishing a second surface 27b (the other main surface) of the flat bar assembly 27 to flatten the second surface 27b and remove foreign substances between the exposed electrodes. Another support sheet 18 is bonded and fixed to the polished second surface 27b. The first surface 27a is then polished. After the first surface 27a and the second surface 27b are polished, the flat bar assembly 27 has a dimension corresponding to a predetermined dimension of the product.

The polishing uses multiple grinding wheels and abrasive powder from coarse- to finer-grit powder. For final polishing, abrasive grains with the mean grain size of 1 μm or less may be used, or abrasive grains with the mean grain size of 0.5 μm or less may be used. This reduces the likelihood that metal particles removed by the polishing from the internal electrodes 5 remain in abrasive scratches, and degrade the insulation between the internal electrodes 5. The abrasive material may be diamond abrasive grains that have high abrasiveness and are less likely to react with a dielectric material or the material for the electrodes during the firing.

In the present embodiment, the flat bar assembly 27 is polished, rather than the individual multiple base precursors 13 being polished. This may eliminate processes of, for example, aligning and fixing the base precursors 13. This structure further reduces the unevenness of the polished surfaces of the base precursors 13 that is caused by wobbly conditions of the base precursors 13 during the polishing. All the base precursors 13 include uniformly polished surfaces.

Abrasive polishing may be replaced with sandpaper tape polishing or cutting with a grinding tool. In these cases as well, the abrasive particles embedded in the abrasive substrate used for finishing may have a mean particle size of 1 μm or less. This reduces the likelihood that the metal particles removed from the internal electrodes 5 degrade the insulation between the internal electrodes 5.

A ceramic green sheet as the protective layer 6 is placed on the polished flat bar assembly 27. The flat bar assembly 27 then undergoes degreasing and firing to sinter the base components 2. The resin is decomposed and burned to be removed from the base components 2. The fired flat bar assembly 27 is divided into pieces to be the base components 2 in FIG. 2. The external electrodes 3 are attached to each base component 2, which is to be the multilayer ceramic capacitor 1 in FIG. 1.

In the present embodiment, the first rods 12 corresponding to multiple parts of the base components 2, together with the second rods 24 as the multiple base precursors 13 aligned in a row, are handled, rather than the individual base components 2 being handled. This facilitates the handling of the base components 2. This improves the product quality and reduces the manufacturing cost.

In the present embodiment, the thermoplastic resin is used to fix the first rods 12 to one another and fix the second rods 24 to one another. The thermoplastic resin may be heated to cause the resin powder to melt and bond or melt and flow. When heated, the molten resin flows in the gaps between the first rods 12 and the gaps between the second rods 24, without an external force being applied to the first rods 12 or the second rods 24. When cooled, the resin has less volumetric shrinkage and thus does not apply unintended stress to the first rods 12 or the second rods 24. This reduces deformation or breakage of the base components 2.

### Second Embodiment

A second embodiment will now be described. In the second embodiment of the present disclosure, the manufacturing method is the same as in the first embodiment of the present disclosure until the multiple first rods 12 illustrated in FIG. 8 are obtained.

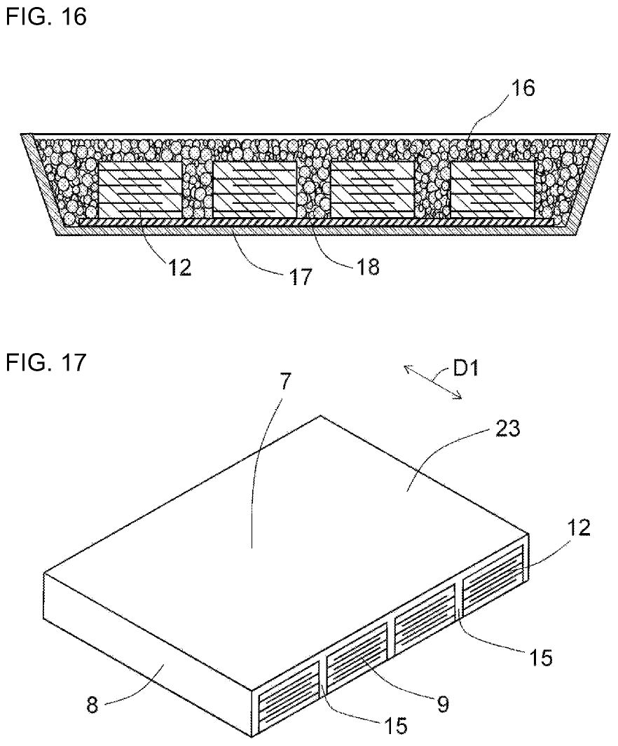

In the present embodiment, as illustrated in FIG. 16, a flat bottom pan 17 with a flat bottom is first prepared, and the multiple first rods 12 are placed on the bottom of the flat bottom pan 17 together with a support sheet 18. The first rods 12 and the support sheet 18 are placed on the bottom of the flat bottom pan 17, with the support sheet 18 being in contact with the bottom. Resin powder 16 is then spread on the bottom of the flat bottom pan 17 from above the multiple first rods 12. With vibration applied to the multiple first rods 12, the resin powder 16 is placed to fill the gaps between the first rods 12 under vibration. A parallel partition is then placed at a predetermined distance from the surfaces (upper surfaces) of the first rods 12 and slid along the surfaces (upper surfaces) of the first rods 12 to scrap off an excess portion of the resin powder 16 to flatten the upper surfaces of the particles of the resin powder 16. The resin powder 16 may have a mean particle size less than or equal to half the length of each gap between the first rods 12, thus increasing the degree of filling the gaps between the first rods 12 with the resin powder 16.

The resin powder 16 is heated to a temperature immediately before the resin powder 16 melts fully. As illustrated in FIG. 16, particles of the resin powder 16 may melt and bond with one another at the points of contact between the particles. This allows the first rods 12 to be fixed to one another with at least a partially melted portion of the resin powder 16. As illustrated in FIG. 17, the resultant flat block 23 includes the first rods 12 integrally fixed to one another. The heating temperature may be adjusted appropriately to integrate all the particles of the resin powder 16. The first rods 12 are thus firmly fixed to one another.

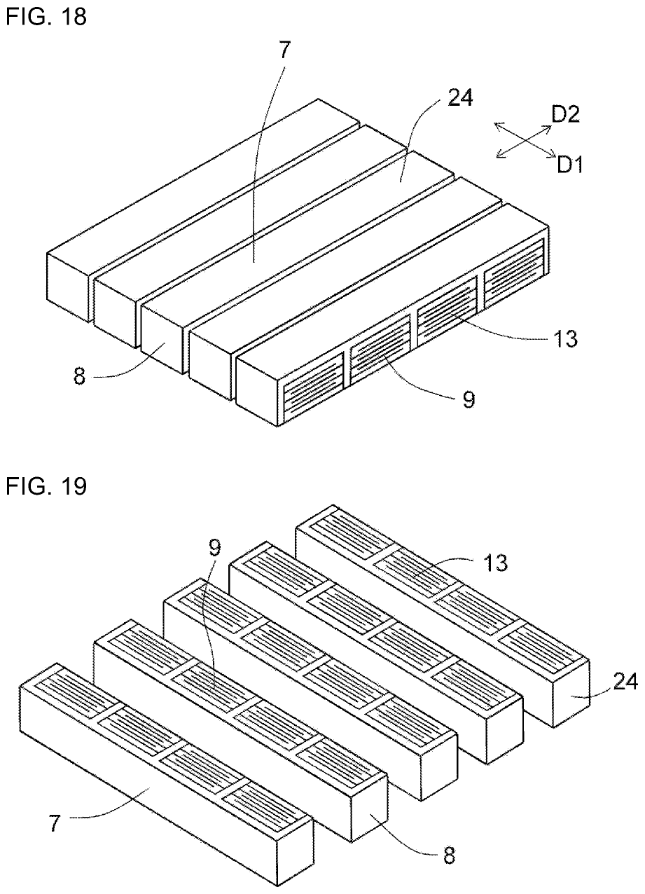

The flat block 23 in FIG. 17 is cut at predetermined intervals in the second direction D2 orthogonal to the first direction D1. FIG. 18 illustrates multiple second rods 24 obtained by cutting the flat block 23. In other words, FIG. 18 illustrates the multiple second rods 24 obtained by the second cutting of the flat block 23. Each second rod 24 includes a cut surface corresponding to the side surface 9 of the base precursor 13. The internal electrode 5 is exposed on each cut surface. In this state, each individual multilayer ceramic electronic component corresponds to the base precursor 13 illustrated in FIG. 3.

As illustrated in FIG. 19, each of the multiple second rods 24 is turned by 90 degrees about the corresponding axis to include one of the corresponding cut surfaces resulting from the second cutting (the surface on which the internal electrode 5 is exposed) facing upward. Under an external force applied to each second rod 24 being turned, the base precursors 13, which are firmly fixed to one another with the resin, are less likely to slip off, or the second rods 24 are less likely to deform.

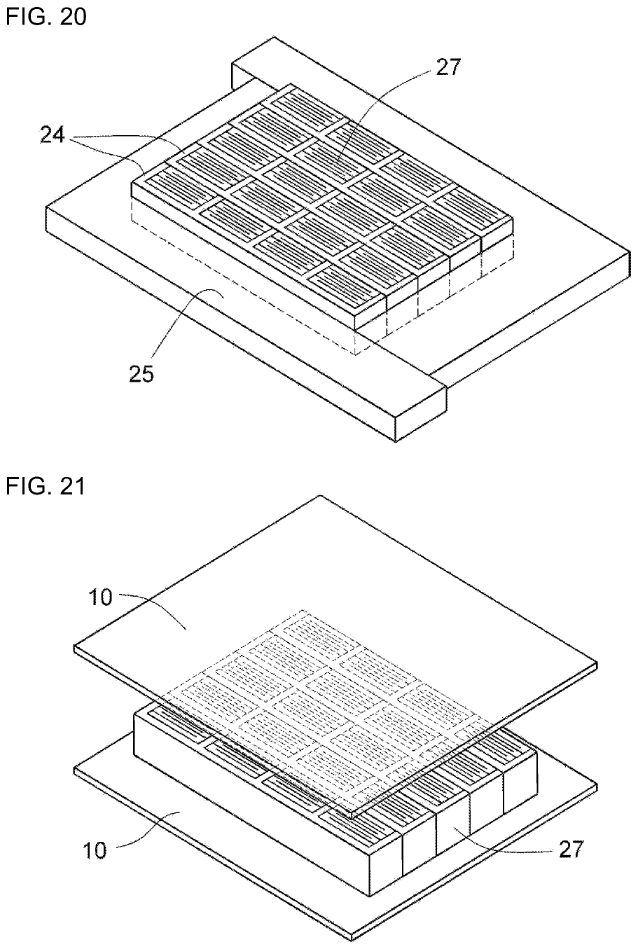

The multiple second rods 24 are assembled into a flat bar assembly 27. In forming the flat bar assembly 27 as illustrated in FIG. 20, two L-shaped frame plates 25 may be used to hold the second rods 24 laterally from outside. In the flat bar assembly 27, the cut surfaces of the second rods 24 may be located substantially in the same plane. The cut surfaces resulting from the second cutting (the surfaces on which the internal electrodes 5 are exposed) correspond to the upper and lower surfaces of the flat bar assembly 27, or in other words, the front and rear surfaces of the flat bar assembly. The flat bar assembly 27 is then heated until immediately after the resin attached to the second rods 24 starts to melt. This allows the flat bar assembly 27 to retain shape although the frame plates 25 are removed. With the multiple second rods 24 being fixed to one another to form the flat bar assembly 27, the L-shaped frame plates 25 can be removed from the flat bar assembly 27. This eliminates unintended space or equipment in the subsequent processes.

As illustrated in FIG. 21, ceramic green sheets 10 as protective layers 6 are placed on the upper and lower surfaces of the flat bar assembly 27 and are bonded. Each ceramic green sheet 10 as the protective layer 6 contains the same composition as the ceramic green sheet included in the base component 2, and has a predetermined thickness to serve as the protective layer 6. The ceramic green sheets 10 may be bonded simultaneously to the two surfaces of the flat bar assembly 27. For ceramic green sheets 10 that do not have sufficient strength to be handled alone, such ceramic green sheets 10 may not be bonded simultaneously to the two surfaces of the flat bar assembly 27, but one ceramic green sheet 10 may be bonded to each surface separately. This allows the ceramic green sheets 10 and the flat bar assembly 27 to be bonded firmly.

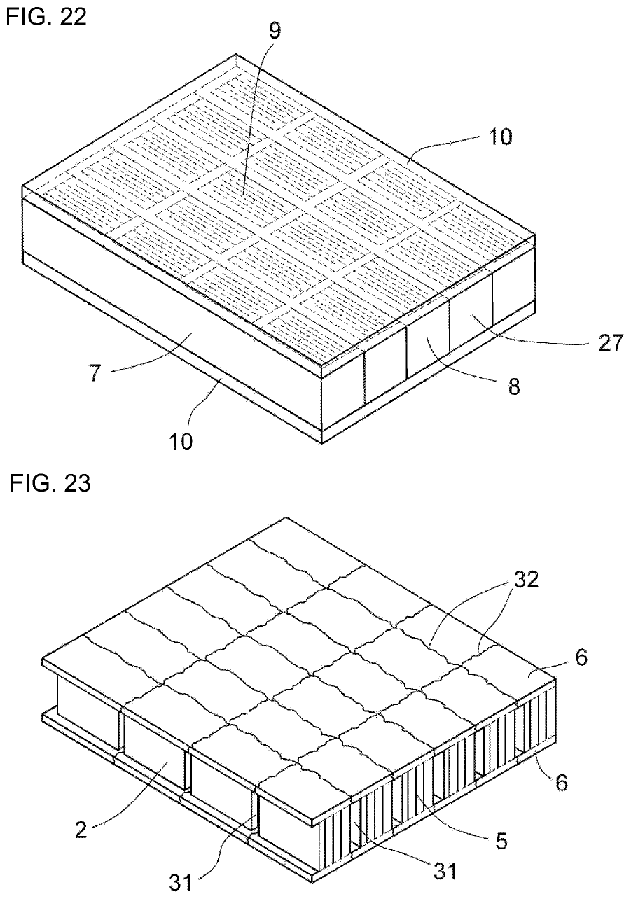

The flat bar assembly 27 with its upper and lower surfaces bonded to the ceramic green sheets 10 then undergoes isostatic pressing to tightly bond the ceramic green sheets as the protective layers 6 to the flat bar assembly 27, thus forming the flat bar assembly 27 as illustrated in FIG. 22. The flat bar assembly 27 in FIG. 22 is after removal of excess portions (outer periphery) of the ceramic green sheets 10. In this state, each individual multilayer ceramic electronic component corresponds to the base component 2 in FIG. 2 as the base precursor 13 illustrated in FIG. 3 with the ceramic green sheets 10 bonded as the protective layers 6.

The flat bar assembly 27 in FIG. 22 undergoes degreasing and firing. The flat bar assembly 27 is first placed on a plate of zirconia. The plate receiving the flat bar assembly 27 is then placed in a degreasing furnace to remove the solvent and the binder. The base component is then sintered in a firing furnace under a high temperature. The firing temperature may be set as appropriate for, for example, the metal material contained in the conductive paste for the internal electrodes 5. The firing temperature may be, for example, from 1100 to 1250° C. The known methods for manufacturing the multilayer ceramic electronic components include placing raw chips as the base components on a ceramic firing plate before firing. In the present embodiment, the flat bar assembly 27 including the multiple base components 2 formed integrally may be simply placed on the firing plate. This eliminates the process for arranging the individual base components 2 on the firing plate.

FIG. 23 is a schematic view of the flat bar assembly 27 after firing. As illustrated in FIG. 23, the resin surrounding the base components 2 is decomposed and burned away. This leaves voids 31 between the base components 2, defining the individual base components 2 each including the protective layer 6 and the base precursor 13 alone. Split lines 32 in the protective layers 6 extend between the base components 2 to substantially divide the base components 2 from one another. During sintering, the base components 2 shrink, widening the gaps between the base components 2. This causes cracks in the sintered ceramic green sheet 10 between the base components 2 as areas with a reduced thickness, thus naturally forming the split lines 32.

For the ceramic green sheet as the protective layer 6 or dried ceramic slurry having a thickness greater than 40 some split lines 32 may not form. The ceramic green sheet as the protective layer 6 or dried ceramic slurry may thus have a thickness of 40 μm or less.

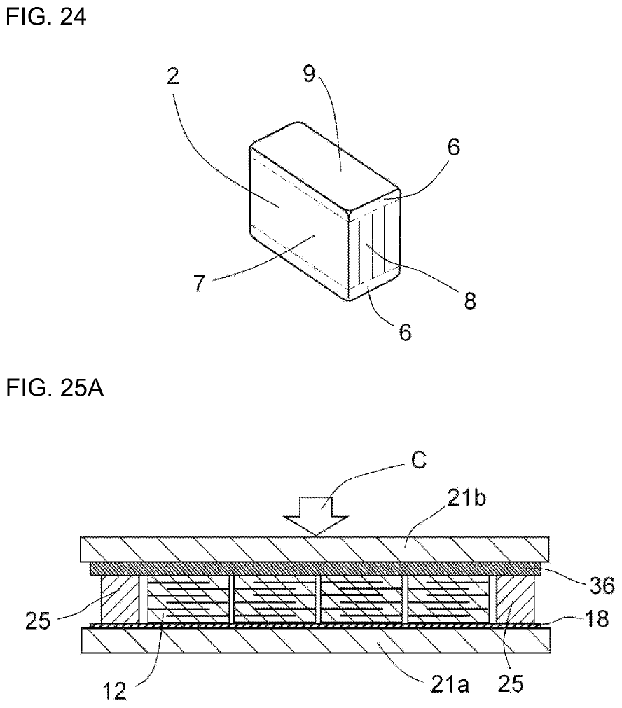

The fired base components 2 then undergo barrel polishing. Barrel polishing is performed to round corners and remove burrs on the base components 2. Known barrel polishing may be performed. In the present embodiment, the base components 2 and the polishing media are placed in a pot of water and rotated for polishing. FIG. 24 illustrates the base component 2 after barrel polishing. As illustrated in FIG. 24, the base component 2 after barrel polishing has no protruding edges of the protective layers 6, which are removed, and has the corners rounded. The base component 2 in FIG. 24 is the same as the base component 2 illustrated in FIG. 2, but is illustrated as viewed in a different direction from the base component 2 in FIG. 2. FIG. 24 illustrates the base component 2 as viewed in the same direction as in FIG. 23. In FIG. 24, an imaginary boundary between the base precursor 13 and each protective layer 6 is indicated by two-dot-dash lines.

The base component 2 in FIG. 2 is obtained in this manner. The external electrodes 3 are attached to each base component 2, which is to be the multilayer ceramic capacitor 1 in FIG. 1.

### Third Embodiment

A third embodiment will now be described. In the third embodiment of the present disclosure, the manufacturing method is the same as in the first embodiment of the present disclosure until the multiple first rods 12 illustrated in FIG. 8 are obtained.

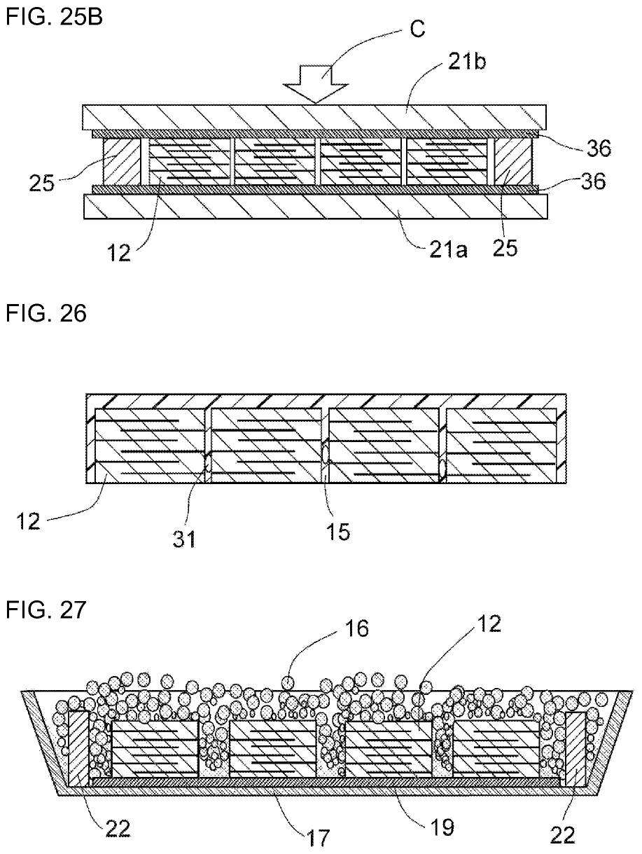

In the present embodiment, as illustrated in FIG. 25A, the multiple first rods 12 are first placed on a first flat plate 21a together with a support sheet 18. The first rods 12 and the support sheet 18 are placed on the upper surface of the first flat plate 21a, with the support sheet 18 being in contact with the upper surface of the first flat plate 21a. The first rods 12 supported on the support sheet 18 are then surrounded by frame plates 25. A resin sheet 36 of a thermoplastic resin is placed on the first rods 12, and a second flat plate 21b is placed on the resin sheet 36. The second flat plate 21b is then pressed in the direction indicated by arrow C under a constant pressure while the resin is being heated to melt.

The molten resin flows downward into the gaps between the first rods 12, causing the first rods 12 to be fixed to one another with the resin. In the present embodiment, a sheet of a thermoplastic resin is placed on the first rods 12 to facilitate the subsequent processes including the heating. The multiple first rods 12 are fixed to one another, and thus can be handled as a single component. This facilitates the machining of the cut surfaces in the subsequent processes. The resin for fixing the first rods 12 can be removed in the firing after the machining.

Each frame plate 25 may include its upper surface flush with or higher than the upper surfaces of the first rods 12. This structure reduces the likelihood that the molten resin flows outside. With the molten resin less likely to flow outside, the first rods 12 may include the upper surfaces flush with or lower than the upper surfaces of the first rods 12. The resin sheet 36 may have a thickness of about 0.3 mm. The resin sheet 36 with less thickness uses less material and thus uses less manufacturing cost. In the present embodiment, the thickness of the resin sheet 36 is set to use less material and to allow the multiple first rods 12 to be handled integrally.

As illustrated in FIG. 25B, the multiple first rods 12 may be sandwiched between two resin sheets 36, and the resin in the two resin sheets may be heated to melt. The first rods 12 sandwiched between the resin sheets from above and below are firmly fixed to one another. The resin may be heated in a vacuum device. In this case, the resin is more likely to flow in the gaps between the first rods 12, causing the first rods 12 to be fixed to one another with the resin with less porosity. This allows the first rods 12 to be fixed to one another more firmly.

FIG. 26 is a schematic cross-sectional view of the first rods 12 illustrated in FIG. 25A with the resin melted by heating. As illustrated in FIG. 26, a molten resin 15 flows downward to fill the gaps between the first rods 12. The resin 15 in the gaps may have a void 31 as illustrated in FIG. 26, but the first rods 12 are firmly fixed to one another with the resin 15. FIG. 26 corresponds to FIG. 17 in the second embodiment. Subsequent processes in the third embodiment are the same as or similar to the processes in the second embodiment and are not described.

### Fourth Embodiment

A fourth embodiment will now be described. In the fourth embodiment of the present disclosure, the manufacturing method is the same as in the first embodiment of the present disclosure until the multiple first rods 12 illustrated in FIG. 8 are obtained.

In the present embodiment, resin powder 16 is first spread on the bottom of a flat bottom pan 17, and the resin powder 16 is heated to melt to form a bottom resin sheet 19 as illustrated in FIG. 27. The multiple first rods 12 illustrated in FIG. 8 are then placed on the bottom resin sheet 19. The resin powder 16 is then spread on the first rods 12. When the resin powder is spread on the first rods 12, vibration is applied to the first rods 12 to cause the gaps between the first rods 12 to be densely filled with the resin powder 16. After the filling using the resin powder 16 under vibration, a parallel partition is placed at a predetermined distance from the surfaces (upper surfaces) of the first rods 12 and slid along the surfaces (upper surfaces) of the first rods 12 to form a layer of the resin powder 16 with a uniform thickness. The resin material or the particle size of the resin powder may be the same as in the first embodiment.

The multiple first rods 12 illustrated in FIG. 27 are placed in an oven at a predetermined temperature to heat and melt the resin powder 16. The predetermined temperature may be set based on, for example, the melting point of the material of the resin powder 16. With the gaps between the first rods 12 filled with the molten resin and the molten bottom resin sheet 19, the molten resin powder 16 and the bottom resin sheet 19 are integrated. The bottom resin sheet 19 and the resin powder 16 may be made of the same material. This allows the bottom resin sheet 19 and the resin powder 16 to show the same melting behavior and higher wettability, causing the first rods 12 to be fixed more firmly to one another.

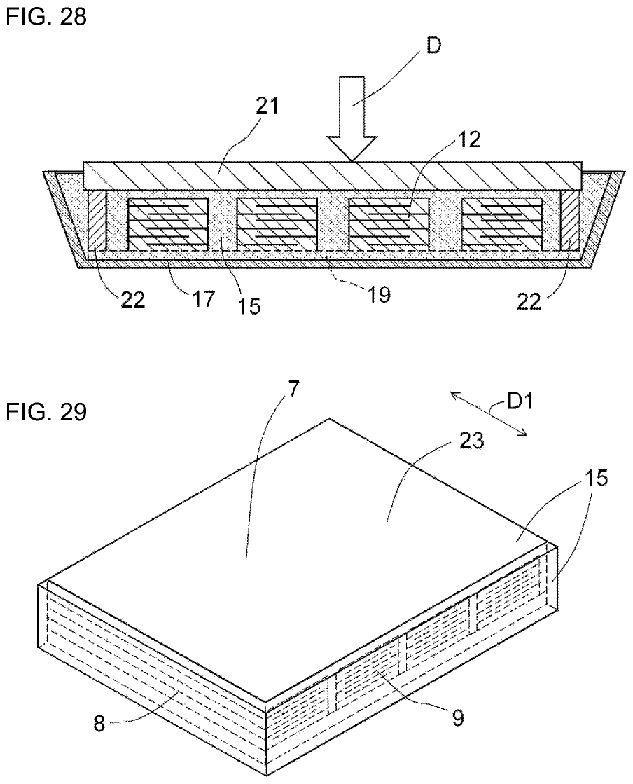

As illustrated in FIG. 28, with the gaps between the first rods 12 filled with a resin 15, a flat plate 21 is placed on the resin 15 and pressed in the direction indicated by arrow D. The flat plate 21 sinks into the molten resin, but is stopped by spacers 22 surrounding the first rods 12. With the resin left to cool down, the layer of resin forms on the first rods 12. The flat plate 21 may be pressed with, for example, a press machine. The flat plate 21 may be pressed during the melting of the resin 15 in the oven or outside the oven. Although the spacers 22 are located on the bottom resin sheet 19 in FIG. 28, the spacers 22 may be located on the flat bottom pan.

FIG. 29 illustrates a flat block 23 as the multiple first rods 12 integrally fixed to one another with the resin 15. As illustrated in FIG. 29, the resin 15 filling the gaps between the first rods 12 extends to the layers of the resin 15 on the upper and lower surfaces of the first rods 12, forming flat resin surfaces on the upper and lower surfaces of the flat block 23.

The flat block 23 in FIG. 29 is then cut at predetermined intervals in the second direction D2 orthogonal to the first direction D1. FIG. 30 illustrates multiple second rods 24 obtained by cutting the flat block 23. In other words, FIG. 30 illustrates the multiple second rods 24 resulting from the second cutting of the flat block 23. The internal electrodes 5 are exposed on the cut surfaces resulting from the second cutting. Each cut surface resulting from the second cutting corresponds to the side surface 9 of the base precursor 13. In this state, each multilayer ceramic electronic component corresponds to the base precursor 13 in FIG. 3.

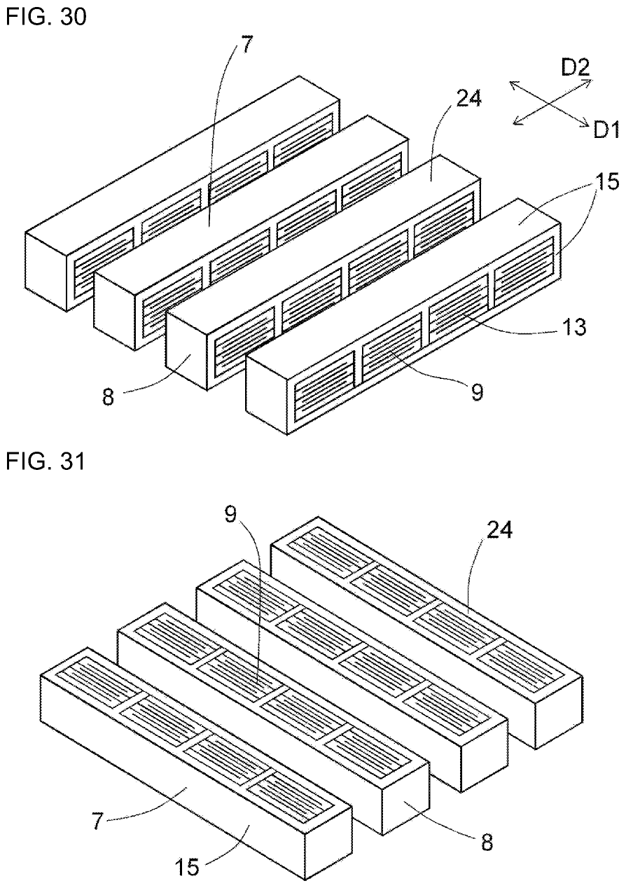

As illustrated in FIG. 31, each of the multiple second rods 24 is turned by 90 degrees about the corresponding axis to include one of the corresponding cut surfaces resulting from the second cutting (the surface on which the internal electrode 5 is exposed) facing upward. When each of the multiple second rods 24 is turned, an external force may be applied to the corresponding second rod 24. However, the base precursors 13 firmly fixed to one another with the resin are less likely to slip off, or the second rods 24 are less likely to deform.

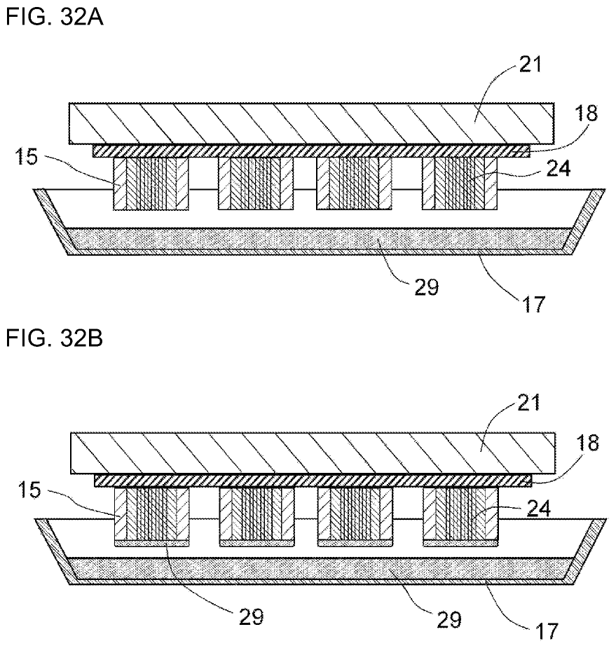

A support sheet 18 as an adhesive releasable sheet is bonded to the entire upper surfaces (the cut surfaces resulting from the second cutting) of the multiple second rods 24 in FIG. 31. A flat plate 21 is then placed on the adhesive releasable sheet as illustrated in FIG. 32A. As illustrated in FIG. 32B, the electrode exposed surfaces (the other cut surfaces resulting from the second cutting) are immersed in ceramic slurry 29 as protective layers 6 and then picked out to be coated with the ceramic slurry 29. The ceramic slurry 29 is then dried at a predetermined temperature. Another support sheet is bonded to the electrode exposed surfaces coated with the ceramic slurry 29. The support sheet 18 on each upper surface is then released off. The same process is performed to coat the other electrode exposed surfaces with the ceramic slurry 29.

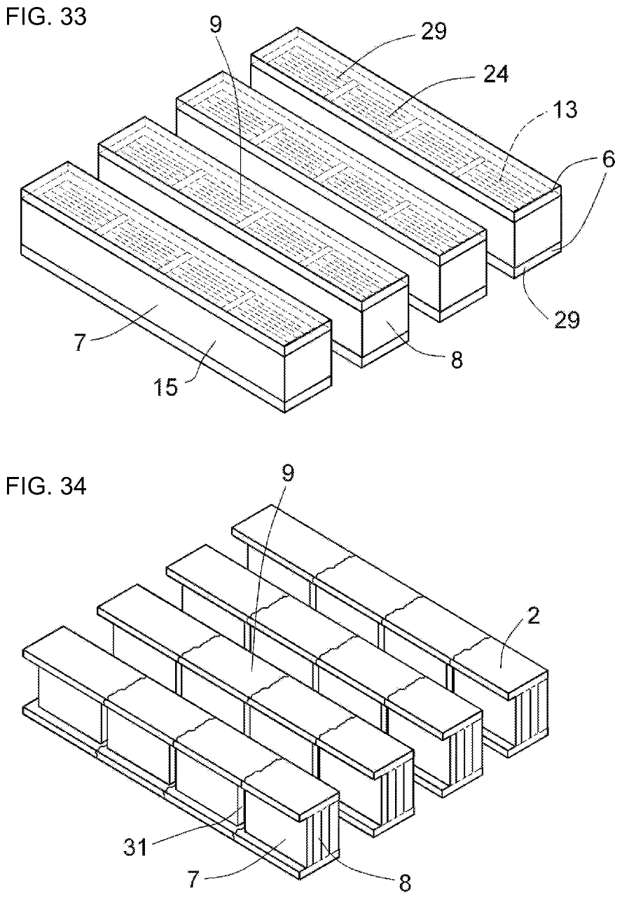

FIG. 33 illustrates the second rods 24 each with the two electrode exposed surfaces coated with the ceramic slurry 29 as the protective layers 6. In each base precursor 13, the electrode exposed surfaces (side surfaces 9) are coated with the ceramic slurry 29 alone, and the main surfaces 7 and the end faces 8 are covered with the resin 15. The known methods for manufacturing the multilayer ceramic electronic components include the dip coating method or the screen printing method for coating electronic components, such as multilayer ceramic electronic components, with slurry or ink. The above known coating methods allow coating of surfaces with slurry or ink. However, the slurry or the ink is likely to spread to other surfaces adjacent to the coated surfaces. With the method for manufacturing multilayer ceramic electronic components according to one or more embodiments of the present disclosure, the surfaces adjacent to the coated surfaces are covered with the resin. This structure effectively reduces the likelihood that the slurry spreads to the surfaces adjacent to the coated surfaces.

The second rods 24 in FIG. 33 undergo degreasing and firing. The second rods 24 are first placed on a ceramic plate. The plate receiving the second rods 24 is then placed in a degreasing furnace to remove the solvent and the binder. The second rods 24 are then sintered in a firing furnace under a high temperature. FIG. 34 is a schematic view of the second rods 24 after firing. As illustrated in FIG. 34, the resin surrounding the base components 2 is decomposed and burned away. This leaves the base components 2 including the protective layers 6 and the base precursor 13 alone with the void 31 between them. Split lines 32 in the protective layers 6 extend between the base components 2 to substantially divide the base components 2 from one another. During sintering, the base components 2 shrink, widening the gaps between the base components 2. This causes cracks in the sintered ceramic slurry 29 between the base components 2 as areas with a reduced thickness, thus naturally forming the split lines 32.

The fired base components 2 then undergo barrel polishing. Barrel polishing is performed to round corners and remove burrs on the base components 2. Known barrel polishing may be performed. In the present embodiment, the base components 2 and the polishing media are placed in a pot of water and rotated for polishing. The base components 2 after barrel polishing are the same as the base component 2 illustrated in FIG. 24.

The base components 2 are thus obtained in the manner described above. The external electrodes 3 are attached to each base component 2, which is to be the multilayer ceramic capacitor 1 in FIG. 1.

### Fifth Embodiment

A fifth embodiment will now be described. In the fifth embodiment of the present disclosure, the manufacturing method is the same as in the third embodiment of the present disclosure until the multiple second rods 24 in FIG. 31 are obtained.

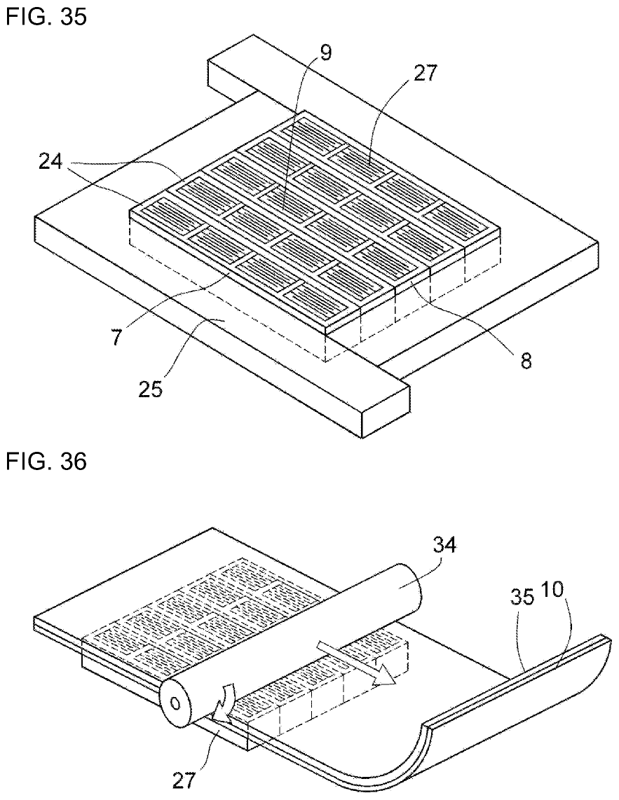

In the present embodiment, the multiple second rods 24 are first collected on a flat plate (not illustrated) to form a flat bar assembly 27. In forming the flat bar assembly 27 as illustrated in FIG. 35, two L-shaped frame plates 25 may be used to hold the second rods 24 laterally from outside. The flat bar assembly 27 includes the upper and lower surfaces corresponding to the cut surfaces (the surfaces on which the internal electrodes 5 are exposed) resulting from the second cutting.

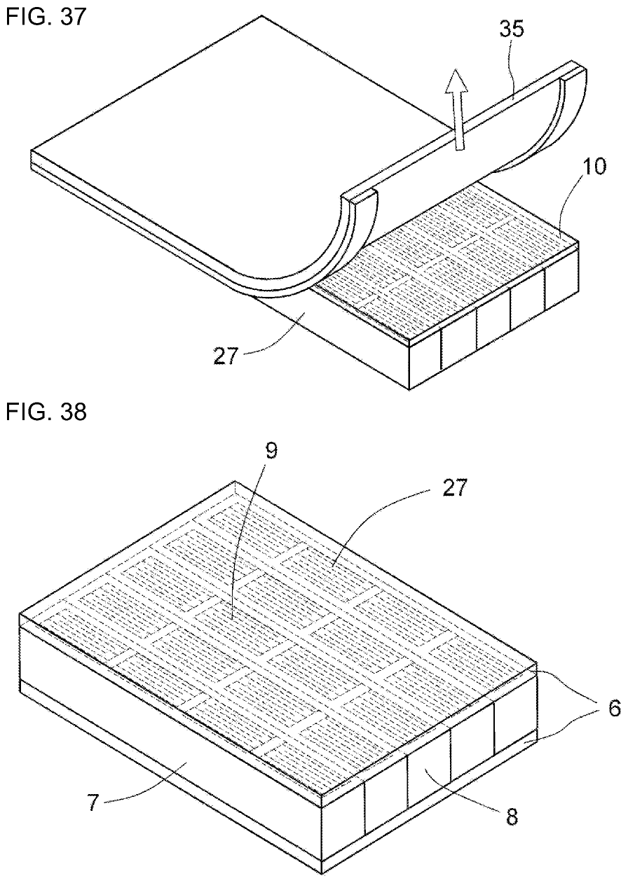

As illustrated in FIG. 36, a ceramic green sheet 10 is formed on a surface (lower surface) of a substrate 35. The substrate 35 is then placed to have the ceramic green sheet 10 on the front surface (upper surface) of the flat bar assembly 27. A heater roller 34 made of an elastic material is placed on the upper surface of the substrate 35 and is rolled along the upper surface under a pressure to place the ceramic green sheet 10 into contact with the front surface (upper surface) of the flat bar assembly 27. As illustrated in FIG. 37, the substrate 35 is turned over and released off to transfer the ceramic green sheet 10 to the front surface (upper surface) of the flat bar assembly 27. The same or similar process is performed on the rear surface (lower surface) of the flat bar assembly 27 to transfer the ceramic green sheet 10 to the rear surface. The flat bar assembly 27 then undergoes isostatic pressing to firmly bond the ceramic green sheets 10 to the front and rear surfaces of the flat bar assembly 27. The substrate 35 may be an elastic rubber sheet made of, for example, silicone, or may be a resin sheet made of, for example, polyethylene terephthalate (PET) or nylon.

FIG. 38 illustrates the flat bar assembly 27 with the ceramic green sheets 10 bonded to its upper and lower surfaces. In each base component 2, the electrode exposed surfaces (cut surfaces resulting from the second cutting) alone are covered with the ceramic green sheets 10 as the protective layers 6. In other words, each base component 2 illustrated is the same as the base component 2 illustrated in FIG. 2.

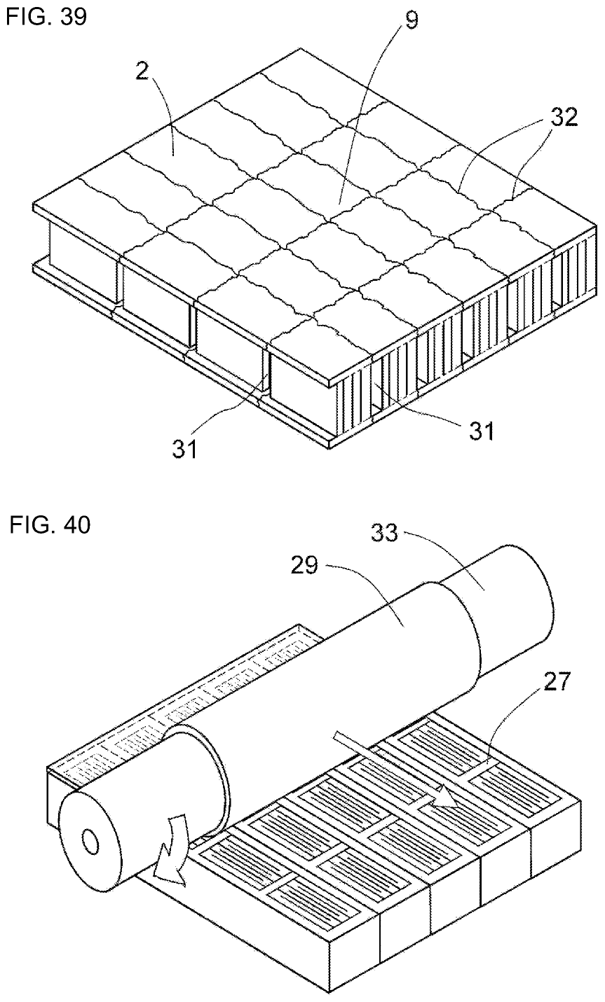

The flat bar assembly 27 in FIG. 38 undergoes degreasing and firing. Degreasing and firing may be performed as in each embodiment described above. FIG. 39 is a schematic perspective view of the sintered flat bar assembly 27 illustrated in FIG. 38. The resin surrounding the base components 2 is decomposed and burned away. This leaves the base components 2 including the protective layers 6 and the base precursor 13 alone with the void 31 between them. Split lines 32 in the protective layers 6 extend between the base components 2 to substantially divide the base components 2 from one another. During sintering, the base components 2 shrink, widening the gaps between the base components 2. This causes cracks in the sintered ceramic green sheet 10 between the base components 2 as areas with a reduced thickness, thus naturally forming the split lines 32.

The fired base components 2 then undergo barrel polishing. Barrel polishing is performed to round corners and remove burrs on the base components 2. Known barrel polishing may be performed. In the present embodiment, the base components 2 and the polishing media are placed in a pot of water and rotated for polishing. The base components 2 after barrel polishing are the same as the base component 2 illustrated in FIG. 24.

The base components 2 are thus obtained in the manner described above. The external electrodes 3 are attached to each base component 2, which is to be the multilayer ceramic capacitor 1 in FIG. 1.

In the present embodiment, in each second rod 24, the ceramic green sheets 10 are applied to the cut surfaces alone and is less likely to spread to the surfaces adjacent to the cut surfaces. This reduces the likelihood that the burrs form on the base component 2 after firing, thus improving the product quality. This also reduces the cost for barrel polishing to remove burrs.

### Sixth Embodiment

A sixth embodiment will now be described. In the sixth embodiment of the present disclosure, the manufacturing method is the same as in the fifth embodiment of the present disclosure until the flat bar assembly 27 in FIG. 35 is obtained.

In the present embodiment, as illustrated in FIG. 40, ceramic slurry 29 pre-applied to the surface of a transfer roller 33 is first transferred to the front surface (upper surface) of the flat bar assembly 27 in FIG. 35. The surface of the transfer roller 33 is made of an elastic material. The ceramic slurry 29 transferred to the upper surface of the flat bar assembly 27 is dried, and the same or similar process is performed on the rear surface (lower surface) of the flat bar assembly 27.

The ceramic slurry 29 may be applied to the transfer roller 33 by, for example, a screen printer. With its roller surface serving as a print target surface, the transfer roller 33 is rolled in synchronization with the printing to receive the ceramic slurry 29 with a predetermined thickness on the roller surface.

In the present embodiment, in each second rod 24, the ceramic slurry 29 is applied to the cut surfaces alone and is less likely to spread to the surfaces adjacent to the cut surfaces. This reduces the likelihood that the burrs form on the base component 2 after firing, thus improving the product quality. This also reduces the cost for barrel polishing to remove burrs.

The flat bar assembly 27, with the ceramic slurry 29 transferred to its front surface (upper surface) and rear surface (lower surface), substantially corresponds to the flat bar assembly 27 illustrated in FIG. 38. The flat bar assembly 27 is then fired to obtain the fired flat bar assembly 27 illustrated in FIG. 39. Subsequent processes in the present embodiment are the same as or similar to the processes in the fifth embodiment and are not described.

### Seventh Embodiment

A seventh embodiment will now be described. In the seventh embodiment of the present disclosure, the manufacturing method is the same as in the fifth embodiment of the present disclosure until the flat bar assembly 27 in FIG. 35 is obtained.

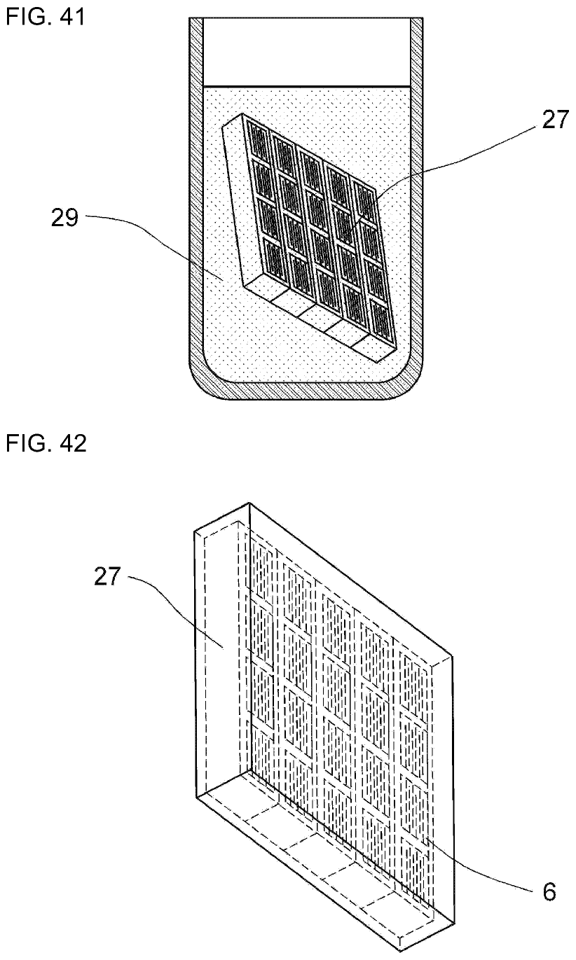

In the present embodiment, as illustrated in FIG. 41, the flat bar assembly 27 in FIG. 35 is first immersed in ceramic slurry 29 in a container and is picked vertically out of the container. The viscosity and the solid content of the ceramic slurry 29 are adjusted appropriately to allow an excess portion of the ceramic slurry 29 to drip from the flat bar assembly 27. This structure thus forms a layer of the ceramic slurry 29 with a predetermined uniform thickness. This forms the layer of ceramic slurry 29 on each of the two electrode exposed surfaces of the flat bar assembly 27 simultaneously, thus reducing the manufacturing cost.

FIG. 42 illustrates the flat bar assembly 27 being dried. The ceramic slurry 29 may be left to dry naturally. The ceramic slurry 29 may be dried using a blade to scrap off an excess portion of the ceramic slurry 29 or using a centrifugal force to blow off an excess portion of the ceramic slurry 29. This shortens the drying time.

The flat bar assembly 27 substantially corresponds to the flat bar assembly 27 illustrated in FIG. 38. Subsequent processes in the seventh embodiment are the same as or similar to the processes in the fifth embodiment and are not described.

### Eighth Embodiment

In the present embodiment, until the first rods 12 in FIG. 7 are obtained from the multilayer base 11 by the first cutting, the processes are the same as or similar to in the embodiments described above, and are not described. The multiple first rods 12 extend in the first direction D1. Each first rod 12 includes a first main surface, a second main surface opposite to the first main surface, a first cut surface, and a second cut surface opposite to the first cut surface. Each first rod 12 also includes a first side surface, and a second side surface opposite to the first side surface. The first and second main surfaces of each first rod 12 correspond to the first and second main surfaces 7a and 7b of the corresponding base precursor 13, and hereafter are denoted with the same reference signs. The first and second cut surfaces of each first rod 12 correspond to the first and second end faces 8a and 8b of the corresponding base precursor 13, and hereafter are denoted with the same reference signs. The first and second side surfaces of each first rod 12 correspond to the first and second side surfaces 9a and 9b of the corresponding base precursor 13, and hereafter are denoted with the same reference signs. Hereafter, the first main surface 7a and the second main surface 7b may be simply referred to as the main surfaces 7 without distinguishing the individual main surfaces. Similarly, the first cut surface 8a and the second cut surface 8b may be simply referred to as the cut surfaces 8 without distinguishing the individual cut surfaces. The first side surface 9a and the second side surface 9b may be simply referred to as the side surfaces 9 without distinguishing the individual side surfaces. Some of the multiple first rods 12 may include the first cut surface 8a or the second cut surface 8b formed with a method other than the first cutting (in other words, the surface corresponding to the end face 8 of the multilayer base 11).

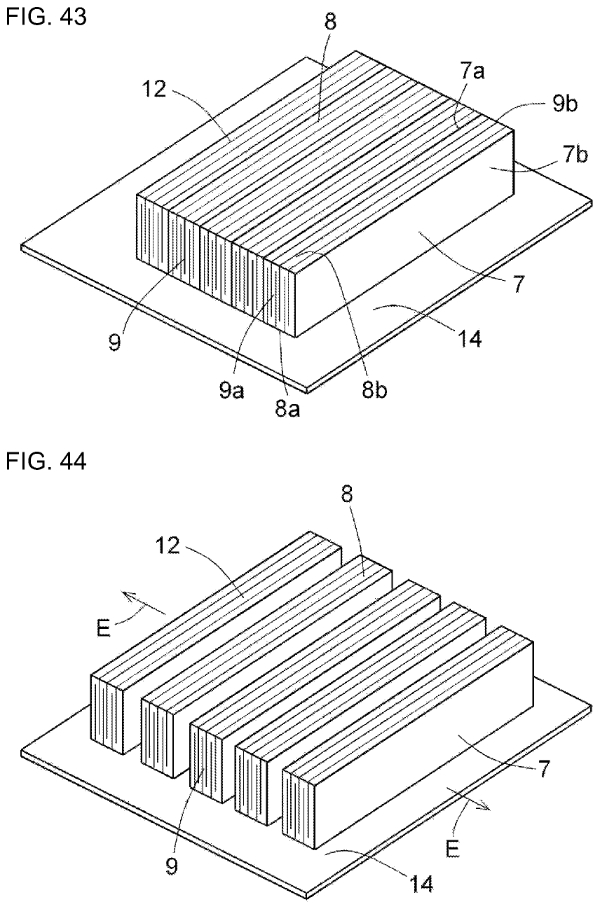

The multiple first rods 12 are formed integrally into a flat block 23. In the above embodiments, as illustrated in FIG. 7, the first main surfaces 7a of the multiple first rods 12 are aligned to be flush with one another, and the first cut surface 8a of each first rod 12 is aligned to face the second cut surface 8b of another first rod 12 adjacent to the corresponding first rod 12. In the present embodiment, as illustrated in FIG. 43, the first cut surfaces 8a of the multiple first rods 12 are aligned to be flush with one another, and the first main surface 7a of each first rod 12 is aligned to face the second main surface 7b of another first rod 12 adjacent to the corresponding first rod 12. In FIG. 43, the first rods 12 in FIG. 7 turned by 90 degrees about their longitudinal axes are aligned with the main surfaces 7 facing each other on the adhesive stretchable sheet 14 that is releasable to include the side surfaces 9 open to the air. Each first rod 12 may be turned by 90 degrees about its longitudinal axis by, for example, causing the internal electrodes made of magnetic metal in the corresponding first rod 12 illustrated in FIG. 7 to react with a magnetic field. In some embodiments, the first rods 12 in FIG. 7 may be attached to the adhesive stretchable sheet 14 to be separated from one another, and the adhesive stretchable sheet 14 is removed. The main surfaces 7 of the first rods 12 may be sandwiched between elastic plates from above and below. The elastic plates may then be moved parallel to each other in opposite directions to roll and turn the first rods 12. After being turned, the first rods 12 each with the cut surfaces 8 facing upward and downward may be placed closer to one another with the main surfaces 7 facing one another. The adhesive stretchable sheet 14 may be attached from above to the first rods 12 and be turned over.

As illustrated in FIG. 44, to increase intervals between the first rods 12 adjacent to one another, two ends of the adhesive stretchable sheet 14 are stretched in the directions indicated by arrows E. The gaps between the first rods 12 may be adjusted by adjusting the stretching length of the adhesive stretchable sheet 14. The first rods 12 may be arranged at intervals of, for example, about 50 to 150 μm to allow the resin powder to flow into the gaps between the first rods 12.

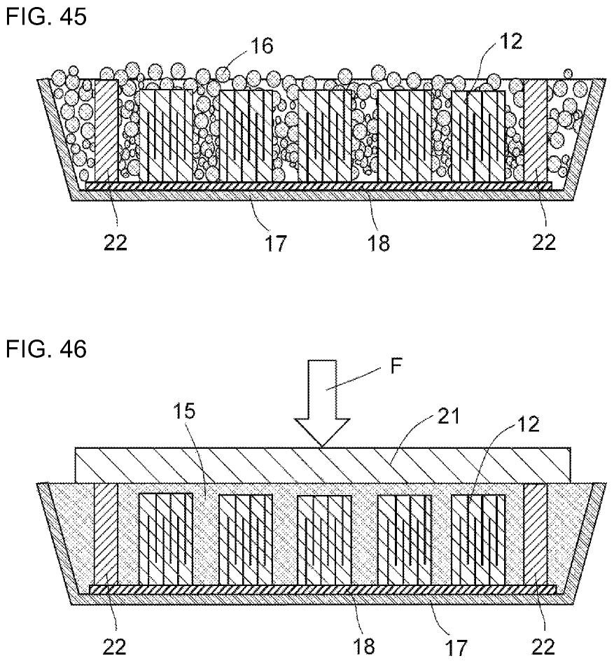

As illustrated in FIG. 45, a flat bottom pan 17 with a flat bottom is first prepared, and the multiple first rods 12 are placed on the bottom of the flat bottom pan 17 together with a support sheet 18. The first rods 12 and the support sheet 18 are placed on the bottom of the flat bottom pan 17, with the support sheet 18 being in contact with the bottom. With resin powder 16 of a thermoplastic resin being placed on at least one surface of each first rod 12, vibration is applied to allow the resin powder 16 to fill the gaps between the first rods 12. A parallel partition (not illustrated) is then placed at a predetermined distance from the surfaces (upper surfaces) of the first rods 12 and slid along the surfaces of the first rods 12 to scrap off an excess portion of the resin powder 16. The mean particle size of the resin powder 16 may be, for example, about 10 to 50 μm.

The resin powder 16 is heated to a predetermined temperature to at least partially melt. The predetermined temperature may be set based on, for example, the melting point of the material of the resin powder 16. The predetermined temperature may be, for example, from about 150 to 180° C.

The resin powder 16 of a thermoplastic resin melts upon heating. The particles of the molten resin powder 16 fuse together at contact surfaces. When heated further, the molten resin 15 flows downward to fill the gaps between the first rods 12.

The melting point of the thermoplastic resin 15 may be lower than or equal to the decomposition temperature of the binder contained in the ceramic green sheets 10 and the internal electrodes 5. This reduces the deterioration of the first rods 12 during the melting of the resin 15. The resin 15 may not contain, for example, a metal, chlorine, or fluorine. This reduces the likelihood that a substance such as a metal, chlorine, or fluorine remains on the surface of the fired base component 2 and deteriorate the product properties.

As illustrated in FIG. 46, with the resin 15 melting in the gaps between the first rods 12, a flat plate 21 is placed on the molten resin 15 and pressed in the direction indicated by arrow F. The flat plate 21 sinks into the molten resin 15 under a pressing force, but is stopped by spacers 22 surrounding the first rods 12. With the resin 15 left to cool down, a layer of the resin 15 forms on the first rods 12. The flat plate 21 may be pressed with, for example, a press machine.

FIG. 47 illustrates a flat block 23 including the multiple first rods 12 integrally fixed to one another with the resin. The multiple first rods 12 extend in the first direction D1. With the resin filling the space between the first rods 12 adjacent to one another and extending to the layer of resin on the first rods 12, the flat block 23 includes a flat resin surface. Although the resin powder is placed to fill the gaps as described above, a thermoplastic resin sheet may be placed on the multiple first rods 12 aligned at constant intervals, and pressed flat while being heated to fill the gaps.

In FIG. 47, the number of base precursors 13 included in the flat block 23 is greater than the number of flat blocks 23 in FIG. 11 in the first embodiment. The difference in the number results from the additional process of turning the first rods by 90 degrees as illustrated in FIG. 43. The flat block 23 has its thickness corresponding to the longitudinal dimension, rather than the width dimension, of each base precursor 13. This structure increases the number of base precursors 13 included in the flat block 23 of the same size. In other words, in the present embodiment, the base precursors 13 can be densely arranged in a plan view. In the present embodiment, although the additional process of turning the first rods 12 is performed, the increased number of base precursors 13 included in the flat block 23 allows more efficient cutting. This improves the manufacturing efficiency of multilayer ceramic electronic components and reduces the manufacturing cost.

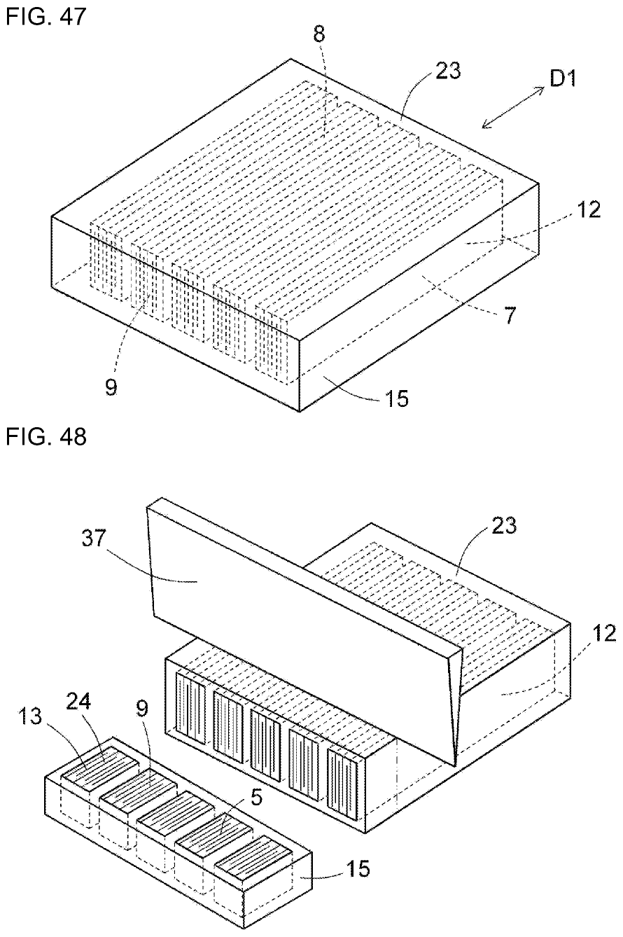

As illustrated in FIG. 48, the flat block 23 is cut into multiple second rods 24 with predetermined dimensions. Each second rod 24 includes the cut surface corresponding to the side surface 9 of the base precursor 13, and the internal electrode 5 is exposed on each cut surface. In this state, each individual multilayer ceramic electronic component corresponds to the base precursor 13 illustrated in FIG. 3. As illustrated in FIG. 48, the flat block 23 may be cut with a press cutter blade 37.

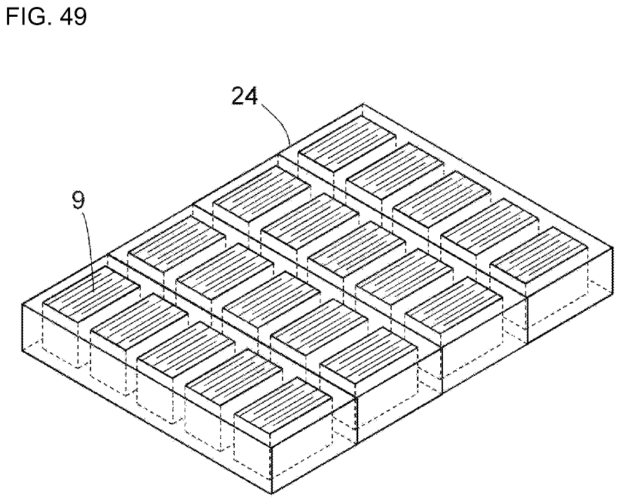

As illustrated in FIG. 49, each of the multiple second rods 24 is turned by 90 degrees about the corresponding axis to include one of the corresponding cut surfaces obtained by the second cutting (the surface on which the internal electrode 5 is exposed) facing upward. To turn the cut surface upward, each elongated second rod 24 may be turned by 90 degrees about its longitudinal axis by, for example, using a magnetic force or sandwiching the corresponding second rod with elastic plates, as for the first rods described above.

The side surfaces 9 open to the air in FIG. 49 are cleaned to remove debris. The polishing described with reference to FIG. 15 may be performed. In some embodiments, other methods, such as etch cleaning or blast cleaning, may be performed. For the side surfaces 9 with no debris, the cleaning may be skipped.

Subsequent processes include forming a protective layer on each side surface 9, which is the same as the process described with reference to FIG. 21 in the first embodiment. The subsequent processes are also the same as or similar to the processes in the first embodiment and are not described.

A method for manufacturing a multilayer ceramic electronic component according to one or more embodiments of the present disclosure improves the handling of base components. This improves the product quality and reduces the manufacturing cost.

The uses of the methods, devices, and materials in the embodiments described above are not limited to the manner in the embodiments alone, and may be combined with one another. In the embodiments described above, the protective layer is made of the same material as the ceramic green sheet, but may be made of any other insulating material. Although not described in the embodiments above, a release sheet or a release agent may be placed between, for example, the flat plates or the frames adjacent to the resin to facilitate removal of resin from the flat plates or from the frames. For example, the ceramic green sheet or the flat bar assembly with ceramic slurry to be the protective layer may be cut before firing, or the flat bar assembly may be polished and then cleaned. Changing the processing conditions in the embodiments or adding new processes to the embodiments as above does not affect the spirit and scope of the present disclosure.

### REFERENCE SIGNS

1 multilayer ceramic capacitor
2 base component
3 external electrode
5 internal electrode
6 protective layer
7 main surface
7a first main surface
7b second main surface
8 end face
8a first end face
8b second end face
9 side surface
9a first side surface
9b second side surface
10 ceramic green sheet
11 multilayer base
12 first rod
13 base precursor
14 adhesive stretchable sheet
15 resin
16 resin powder
17 flat bottom pan
18 support sheet
19 bottom resin sheet
21 flat plate
21a first flat plate
21b second flat plate
22 spacer
23 flat block
24 second rod
25 frame plate
27 flat bar assembly
27a first surface
27b second surface
28 abrasive disc
29 ceramic slurry
31 void
32 split line
33 transfer roller
34 heater roller
35 substrate
36 resin sheet
37 press-cutting blade

1. A method for manufacturing a multilayer ceramic electronic component, the method comprising:
cutting, at predetermined intervals, a multilayer base including ceramic green sheets and electrode layers stacked alternately to form a plurality of first rods extending in a first direction;
placing a resin on at least one surface of each of the plurality of first rods and between adjacent first rods of the plurality of first rods to form a flat block including the plurality of first rods fixed to one another;
cutting the flat block at predetermined intervals in a second direction orthogonal to the first direction to form a plurality of second rods including a plurality of base precursors aligned in a row;
machining a cut surface of each of the plurality of second rods including the plurality of base precursors to form a plurality of base components;
firing the plurality of base components to sinter the plurality of base components; and
removing the resin.

2. The method according to claim 1, further comprising:
placing, after the cutting the multilayer base, the plurality of first rods on an adhesive stretchable sheet; and
stretching the adhesive stretchable sheet to form, between adjacent first rods of the plurality of first rods, a gap to receive the resin.

3. A method for manufacturing a multilayer ceramic electronic component, the method comprising:
cutting, at predetermined intervals, a multilayer base including ceramic green sheets and electrode layers stacked alternately to form a plurality of first rods, each of the plurality of first rods extending in a first direction and including a first main surface, a second main surface opposite to the first main surface, a first cut surface, and a second cut surface opposite to the first cut surface;
aligning the plurality of first rods at a constant gap from one another to place a resin in the constant gap to form a flat block including the plurality of first rods fixed to one another;
cutting the flat block at predetermined intervals in a second direction orthogonal to the first direction to form a plurality of second rods including a plurality of base precursors aligned in a row;
machining a cut surface of each of the plurality of second rods including the plurality of base precursors to form a plurality of base components;
firing the plurality of base components to sinter the plurality of base components; and
removing the resin.

4. The method according to claim 3, wherein
the aligning the plurality of first rods includes aligning the plurality of first rods to cause the first main surfaces of the plurality of first rods to be flush with one another and to cause the first cut surface of each of the plurality of first rods to face the second cut surface of another first rod of the plurality of first rods adjacent to the first rod before placing the resin in the constant gap to form the flat block.

5. The method according to claim 3, wherein
the aligning the plurality of first rods includes aligning the plurality of first rods to cause the first cut surfaces of the plurality of first rods to be flush with one another and to cause the first main surface of each of the plurality of first rods to face the second main surface of another first rod of the plurality of first rods adjacent to the first rod before placing the resin in the constant gap to form the flat block.

6. The method according to claim 1, wherein
the resin is a thermoplastic resin.

7. The method according to claim 6, wherein
the placing the resin includes
placing a resin sheet in contact with the at least one surface of each of the plurality of first rods, and
heating the resin sheet to melt the resin sheet.

8. The method according to claim 6, wherein
the placing the resin includes
placing resin powder on the at least one surface of each of the plurality of first rods and between adjacent first rods of the plurality of first rods, and
heating the resin powder to melt at least a part of the resin powder.

9. The method according to claim 8, further comprising:
placing, with at least a part of the resin being melted, a mold with a flat surface to face the flat block; and
pressing the mold against the flat block to flatten a surface of the resin.

10. The method according to claim 1, wherein
the resin has a melting point lower than or equal to a decomposition temperature of a binder included in the ceramic green sheets and the electrode layers.

11. The method according to claim 1, further comprising:
preparing a flat plate before the machining;
aligning the plurality of second rods on the flat plate to place the cut surfaces of the plurality of second rods into contact with a surface of the flat plate; and
placing adjacent second rods of the plurality of second rods into contact with one another to form a flat bar assembly including the plurality of second rods formed integrally.

12. The method according to claim 11, further comprising:
heating the flat bar assembly before cooling the flat bar assembly to bond adjacent second rods of the plurality of second rods to each other with the resin.

13. The method according to claim 11, wherein
the machining includes polishing or grinding the flat bar assembly.

14. The method according to claim 1, wherein
the machining includes placing a first surface of the flat bar assembly into contact with a ceramic green sheet with a predetermined thickness.

15. The method according to claim 11, wherein
the machining includes placing each of a first surface and a second surface of the flat bar assembly opposite to each other into contact with a ceramic green sheet with a predetermined thickness.

16. The method according to claim 11, wherein
the machining includes
applying ceramic slurry with a predetermined thickness to each of a first surface and a second surface of the flat bar assembly opposite to each other, and
drying the applied ceramic slurry.

17. The method according to claim 11, wherein
the machining includes
immersing the flat bar assembly in ceramic slurry,
picking the flat bar assembly out of the ceramic slurry, and
drying the flat bar assembly with the ceramic slurry.
